(19) United States
(12) Patent Application Publication
(10) Pub. No.: US 2014/0252902 A1
(43) Pub. Date: Sep. 11, 2014

(54) Binkowski Electrical Machine

(71) Applicant: Kazimierz M. Binkowski, Shelton, CT (US)

(72) Inventor: Kazimierz M. Binkowski, Shelton, CT (US)

(21) Appl. No.: 13/790,834

(22) Filed: Mar. 8, 2013

(51) Int. Cl. H02K 1/27

(52) U.S. Cl. CPC H02K 1/27
USPC 310/156.08

(57) ABSTRACT

An electrical machine includes at least one magnet that provides a dipole magnetic field having a primary direction. A plurality of elongate conductive members is spaced from one another in a plane perpendicular to this primary direction. The members extend radially away from a central axis parallel to this primary direction. The magnet(s) or the plurality of members is coupled to a shaft that rotates about the central axis whereby the members interact with the magnetic field during such rotation. At least one electrical circuit provides for electric current flow through the members during such rotation. In a generator mode, the shaft is driven by an external source, and the electrical circuit produces current flow during shaft rotation. In a motor mode, an external source supplies current flow through the circuit, which causes interaction between the members and the magnetic field produced by the magnet to rotate the shaft.

### BACKGROUND

1. Field

The present application relates to electrical machines, including electrical generators which provide for conversion of mechanical motion into electrical energy as well as electrical motors which provide for conversion of electrical energy into mechanical motion.

2. Related Art

An electrical machine is an apparatus that converts mechanical energy to electrical energy, converts electrical energy to mechanical energy, or changes alternating current from one voltage level to a different voltage level. Electrical machines as employed in industry fall into three categories (electrical generators, electrical motors, and transformers) according to how they convert energy. Electrical generators convert mechanical energy (e.g., rotation of an input shaft) to electrical energy. Electrical motors convert electrical energy to mechanical energy (e.g., rotation of an output shaft). Transformers change the voltage of alternating current. Electrical generators and electrical motors can have essentially the same components and are very similar in outward appearance. They differ only in the way they are used. In the electrical generator, the rotation of an input shaft turns an armature and the moving armature generates electrical power. In the electrical motor, electrical power forces the armature to turn and the moving armature drive rotation of an output shaft (which is coupled to a mechanical load).

Sir Michael Faraday built the world's first electrical motor in 1821. Then about ten years later, he did use the same logic and ideas in a reverse way to discover the principles of operation of the first generator as well. The Faraday's motor was a primitive device that included a circuit comprised of a wire, a battery and a dish of mercury. The wire was arranged so that one end hung free in the mercury bath. When current ran through the circuit, it generated a circular magnetic field around the wire. The wire's magnetic field interacted with the magnetic field of a permanent magnet fixed to the center of the dish of mercury to cause the free end of the wire to rotate about the permanent magnet.

Direct current (DC) is the unidirectional flow of electric charge. Direct current is produced by sources such as batteries, thermocouples, solar cells, and commutator-type electrical machines. Direct current may flow in a conductor such as a wire, but can also flow through semiconductors, insulators, or even through a vacuum as in electron or ion beams. The electric charge flows in a constant direction, distinguishing it from alternating current (AC). In alternating current, the movement of electric charge periodically reverses direction. Direct current may be obtained from alternating current by the use of a current-switching arrangement called a rectifier, which contains electronic elements (usually) or electromechanical elements (historically) that allow current to flow only in one direction. Alternating current can be made into direct current with a rectifier or commutator.

The first commercial electric power transmission system (developed by Thomas Edison in the late nineteenth century) used direct current. Today, electric power distribution utilizes alternating current (developed by Nicolas Tesla in the late nineteenth and early twenty centuries).

Many applications that require DC electrical power convert mains AC electrical signals to DC electrical signals using a rectifier. For cases where mains AC power is unavailable or where there is an economical source of electric generation, an AC generator can be produce AC electrical signals and a rectifier can be used to convert the AC electrical signals to a DC electrical signals.

The alternating current (AC) generators and motors can also be used as DC generators or motors. In a DC generator (which is basically an AC generator with a commutator), the commutator reverses the armature coil's connection to an external circuit to provide so-called, unidirectional (i.e. direct) current to the external circuit. In a DC motor, the commutator reverses the current direction in the moving coils of the motor's (shaft) armature thus producing a steady rotating force. The commutator is typically realized by a set of copper segments, fixed around the part of the circumference of the rotating machine (rotor shaft) and a set of spring loader brushes fixed to the stationary frame of the machine. Two (or more) fixed brushes connect to the external circuit, which is either a source of current for a motor or a load for a generator. While commutators are widely applied in direct current electrical machines to convert AC voltage to DC voltage, they have limitations. More specifically, during the complete rotation (360°) of the armature, the amplitude and direction of the current follows one full cycle of a sine wave. The commutator maintains the ‘positive (+)’ AC direction during the first half of a shaft rotation (between 0° and 180° of a shaft revolution) then drops off (removes) the ‘negative (−)’ opposite AC direction during the second half of the shaft rotation (between the 180° and 360° of a shaft revolution) and thus provides for rectification of the induced AC current. The real valuable and productive part of the induced AC current lies only in a 40° angle range for the DC conversion—on both max peak values at the (+) 90° and the (−) 270° as the AC of the revolution of the armature—which means that the process is not effective for the DC conversion in the remaining 320° angle range of revolution of the armature in converting the AC voltage to DC voltage. Moreover, the rectification results in further significant inefficiencies (typically in the range of 10% to 30% power loss). In this manner, the commutation and rectification of the AC sine-waveform generated by or applied to the rotating armature has limited efficiency in transforming the input mechanic energy imparted to the rotating armature into electrical energy (as a generator) or in transforming input electrical energy imparted to the rotating armature into mechanical rotational energy (as a motor). Such inefficiencies have limited the practical application of commutator-type electrical machines. Moreover, the AC power due to its constant switching flow direction and polarity has no ability to develop and maintain a positive constant torque (turning moment). In contrast, DC power has the ability to develop and maintain a positive constant torque due to its unidirectional flow of its voltage and constant polarity.

A homopolar generator is a DC electrical generator comprising an electrically conductive copper disc or cylinder rotating in a plane perpendicular to a uniform static magnetic field. A potential difference is created between the center of the disc and the rim (or ends of the cylinder). The electrical polarity of the potential difference depends on the direction of rotation of the disc or cylinder. The voltage is typically very low, on the order of a few volts in the case of small demonstration models, but very large research generators can produce about hundreds of volts, and some systems have multiple homopolar generators in series to produce an even larger voltage. They are unusual in that they can source tremendous high electric current, some more than a million amperes, because the homopolar generator can be made to have very low internal resistance. In a homopolar generator, the disc or cylinder always encounters magnetic flux of the same polarity everywhere. The induced voltage is typically very low but currents of very large amplitudes can be supplied by such machines. Homopolar generators are used in some applications like pulse-current and MHD generators, liquid metal pumps or plasma rockets.

The homopolar generator was developed first by Michael Faraday during his experiments in 1831. It is frequently called the Faraday disc in his honor. The Faraday disc was primarily inefficient due to counter flows of current. While current flow was induced directly underneath the magnet, the current would circulate backwards in regions outside the influence of the magnetic field. This counter flow limits the power output and induces waste heating of the copper disc. Later homopolar generators would solve this problem by using an array of magnets arranged around the disc perimeter to maintain a steady field around the circumference, and eliminate areas where counter flow could occur.

Even though homopolar machines are DC generators in a strict sense that they ‘generate’ steady voltages, they are not quite useful for day to day use. More practical converters can be found in the DC machine family called “hetero-polar” machines (known as basic AC commutator's machines). Homopolar generators have not had significant commercial success because they are inherently low voltage and high current electrical machines. A 12 kW homopolar generator could be rated at 2 volts and 6,000 amps. Such low voltage high current output cannot be used for every day power supply needs as it is extremely difficult to convert to mains power supply levels (120 volt AC power).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments are provided for an electrical machine that includes one or more magnets that provide a dipole magnetic field having a primary direction. A plurality of elongate conductive members (or even single conductive member) is disposed in a plane that is oriented perpendicular to this primary direction. The elongate conductive members are spaced apart from one another with non-electrically-conducting matter therebetween. The elongate conductive members (or member) extend radially away from a common central axis that is oriented parallel to this primary direction. The magnet(s) or the plurality of elongate conductive members is rigidly coupled to a rotating shaft that is configured to rotate about the central axis whereby the elongate conductive members (or member) interact with the dipole magnetic field flux during such rotation. At least one electrical circuit provides for electric current flow through the elongate conductive members (or member) during rotation of the shaft. In a generator mode, the rotation of the shaft is driven by an external source, and the electrical circuit(s) produces electrical current flow during shaft rotation. In a motor mode, an external source supplies electrical current flow through the electrical circuit(s), which causes interaction between the elongate conductive members (or member) and the magnetic field produced by the magnet(s) to drive rotation of the shaft.

In one embodiment, the elongate conductive members (or member) comprise rods of a solid conductive material. The elongate conductive members comprise rods of a solid conductive material, distributed in the radial direction orthogonal to the central axis of at least one layer along the central axis can include a plurality of layers.

In one embodiment, the at least one magnet is fixed in a stationary position, and the elongate conductive members are configured to rotate about the central axis. At least one brush can be configured to interface to the elongate conductive members while the elongate conductive members interact with the dipole magnetic field flux during such rotation.

In another embodiment, the elongate conductive members (or member) can be fixed in stationary positions, and the magnet(s) can be configured to rotate about the central axis.

In one embodiment, the magnet is realized by a plurality of magnet unit pairs that are distributed about the central axis on opposite sides of the plane of the elongate conductive members. The plurality of magnet unit pairs include at least one set of magnet unit pairs that are offset from one another along a radial direction orthogonal to the central axis. For a given set of magnet unit pairs that are offset from one another along a radial direction orthogonal to the central axis, the electro-magnetic field lines of force (flux) produced by the magnet unit pairs of the given set can increase in coverage area as a function of radial offset from the central axis.

The magnet(s) can be realized by at least one pair of permanent magnets disposed on opposite sides of the plane of the elongate conductive members (or member). The magnet(s) can also be realized by at least one pair of electro-magnets disposed on opposite sides of the plane of the elongate conductive members (or member).

In one embodiment, the magnet is realized by a pair of annular magnets disposed on opposite sides of the plane of the elongate conductive members (or member). The pair of annular magnets can be implemented by two electro-magnets, wherein each electro-magnet having an annular core with an inner surface disposed opposite an outer surface, an inner winding including a plurality of conductive loops supported on the inner surface of the annular core, and an outer winding including a plurality of conductive loops supported on the outer surface of the annular core. The conductive loops of the inner winding can be configured to carry current in a first direction about the central axis of the annular core, and the conductive loops of the outer winding can be configured to carry current in a second direction about the central axis of the annular core, wherein the second direction is opposite the first direction. The conductive loops of at least one of the inner winding and the outer winding can include a plurality of layers.

In one embodiment, the magnet(s) covers limited subsets of the elongate conductive members at corresponding predetermined rotational intervals of the electrical machine, and the electrical circuit includes at least one commutator brush and commutator element that are configured to provide electrical connection to the limited subsets of elongate conductive members at the corresponding predetermined rotational intervals of the electrical system. The at least one commutator brush and commutator element are further configured to disconnect from at least one elongate conductive member that is not covered by the magnet(s) at the predetermined rotational intervals of the electrical machine in order to limit current leakage through the at least one elongate conductive member that is not covered by the magnet(s). The commutator brush can be stationary and the commutator element can rotate with the shaft for embodiments where the elongate conductive members rotate with the shaft. Alternatively, the commutator brush can rotate with the shaft and the commutator element can be stationary for embodiments where the elongate conductive members are stationary.

In another embodiment, the electrical circuit includes a plurality of diodes that limit current flow through the elongate conductive members in order to limit current leakage through at least one elongate conductive member that is not covered by the magnet(s) of the machine.

In one embodiment, the at least one electrical circuit can carry unidirectional direct current flow during rotation of the shaft.

In another embodiment, the magnet(s) are realized by at least two magnets that produce dipole magnetic fields of opposite polarity with respect to one another, and the least one electrical circuit carries bidirectional current flow during rotation of the shaft.

In one embodiment, the electrical current flow through the electrical circuit of the machine is continuous direct current.

In another embodiment, the electrical current flow through the electrical circuit of the machine is interrupted direct current.

In one embodiment, the electrical current flow through the electrical circuit of the machine is alternating dual-polarity current.

In yet another embodiment, the at least one electric circuit includes a plurality of electric circuits that produce a corresponding plurality of electric current flows induced by interaction between the elongate conductive members and the dipole magnetic field produced by the magnet(s) during rotation of the shaft, wherein the plurality of electric current flows vary over time with predetermined phase relations.

In another aspect, an apparatus for generating an electromagnetic field is provided that includes an annular core with an inner surface disposed opposite an outer surface. An inner winding having a plurality of conductive loops is supported on the inner surface of the annular core. An outer winding having a plurality of conductive loops is supported on the outer surface of the annular core. The conductive loops of the inner winding are configured to carry current in a first direction about the central axis of the annular core. The conductive loops of the outer winding are configured to carry current in a second direction about the central axis of the annular core, wherein the second direction is opposite the first direction. The conductive loops of at least one of the inner winding and the outer winding comprise a plurality of layers. The conductive loops of the inner winding and the outer winding are preferably substantially orthogonal to the central axis of the annular core.

In another aspect, an apparatus can be realized by at least two individual stages, while each stage can have separate shaft with elongate conductive members, rotating within at least one dipole magnetic field produced by at least one magnets unit for generating electrical energy. The at least two individual stages can be arranged in a vertical or horizontal configuration, and can have a plurality of magnet unit pairs that are distributed radially about the central axis on opposite sides of the plane of the elongate conductive members. The stages can generate electrical energy with different phase relationships. The electrical energy of the stages can be realized by unidirectional current or bidirectional current flow during operation of the stages. The stages can also employ separate shafts per stage, which can all rotate in the same rotational direction, in opposite rotational directions, or combinations thereof. Each stage also employs at least one magnet unit pair that produces a dipole magnetic field flux. The magnet unit pairs for each stage can have the same polarity (or opposite polarity) with respect to one another.

### BRIEF DESCRIPTION OF THE DRAWINGS

FIG. 1A is a partial perspective schematic view of a first embodiment of an electrical machine according to the present application.

FIG. 1B is a partial side schematic view of the electrical machine of the first embodiment of FIG. 1A.

FIG. 1C is a cross-section schematic view of the electrical machine of the first embodiment of FIG. 1A.

FIG. 1D is a top perspective schematic view of components of the electrical machine of the first embodiment of FIG. 1A.

FIG. 1E is a top schematic view of a second embodiment of an electrical machine according to the present application.

FIG. 1F is a cross-section schematic view of the electrical machine of the second embodiment of FIG. 1E.

FIG. 1G is a top schematic view of a third embodiment of an electrical machine according to the present application.

FIG. 1H is a top schematic view of a fourth embodiment of an electrical machine according to the present application.

FIG. 1I is a cross-section schematic view of a fifth embodiment of an electrical machine according to the present application.

FIG. 1J is a top schematic view of the electrical machine of the fifth embodiment of FIG. 1I.

FIG. 1K is an oscilloscope signal trace of a continuous DC voltage signal produced by an embodiment of an electrical machine similar to the first embodiment of FIGS. 1A to 1D.

FIG. 1L is a schematic diagram of an exemplary electrical circuit that is used to interface the electrical machine to an oscilloscope for capturing the signal trace of FIG. 1K.

FIG. 2A is a top schematic view of a sixth embodiment of an electrical machine according to the present application.

FIG. 2B is a top schematic view of a seventh embodiment of an electrical machine according to the present application.

FIG. 2C is a top schematic view of an eighth embodiment of an electrical machine according to the present application.

FIG. 2D is a front schematic view of a ninth embodiment of an electrical machine according to the present application, which combines two vertical stages similar to the seventh embodiment of the electrical machine shown on FIG. 2B.

FIG. 2E is an oscilloscope signal trace of an interrupted-mode DC voltage signal produced by an embodiment of an electrical machine similar to the seventh embodiment of FIG. 2B.

FIG. 3A is a top schematic view of a tenth embodiment of an electrical machine according to the present application.

FIG. 3B is a top schematic view of an eleventh embodiment of an electrical machine according to the present application.

FIG. 3C is a top schematic view of a twelfth embodiment of an electrical machine according to the present application.

FIG. 3D is an oscilloscope signal trace of an alternating dual-polarity voltage signal produced by an embodiment of an electrical machine similar to the tenth embodiment of FIG. 3A.

FIG. 4 is a side schematic view of a thirteenth embodiment of an electrical machine according to the present application.

FIG. 5A is a side schematic view of a fourteenth embodiment of an electrical machine according to the present application.

FIG. 5B is a sectional 5B-5B top schematic view of the fourteenth embodiment of FIG. 5A.

FIG. 6A is a partial side schematic view of a fifteenth embodiment of an electrical machine according to the present application.

FIG. 6B is a top schematic view of the fifteenth embodiment of FIG. 6A.

FIG. 7A is a cross section schematic view of a sixteenth embodiment of an electrical machine according to the present application.

FIG. 7B is a right side schematic view of the sixteenth embodiment of FIG. 7A of the electrical machine.

FIG. 7C is a sectional 7C-7C schematic view of the sixteenth embodiment of FIG. 7A of the electrical machine.

FIG. 7D is a sectional 7D-7D schematic view of the sixteenth embodiment of FIG. 7A of the electrical machine.

FIG. 8A is a cross-section view of another alternate embodiment of an electrical machine according to the present application.

FIG. 8B is a sectional 8B-8B top schematic view of the electrical machine of the embodiment of FIG. 8A.

### DETAILED DESCRIPTION OF THE PREFERRED EMBODIMENTS

The detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Note that in the drawings like numerals represent like parts throughout the several views.

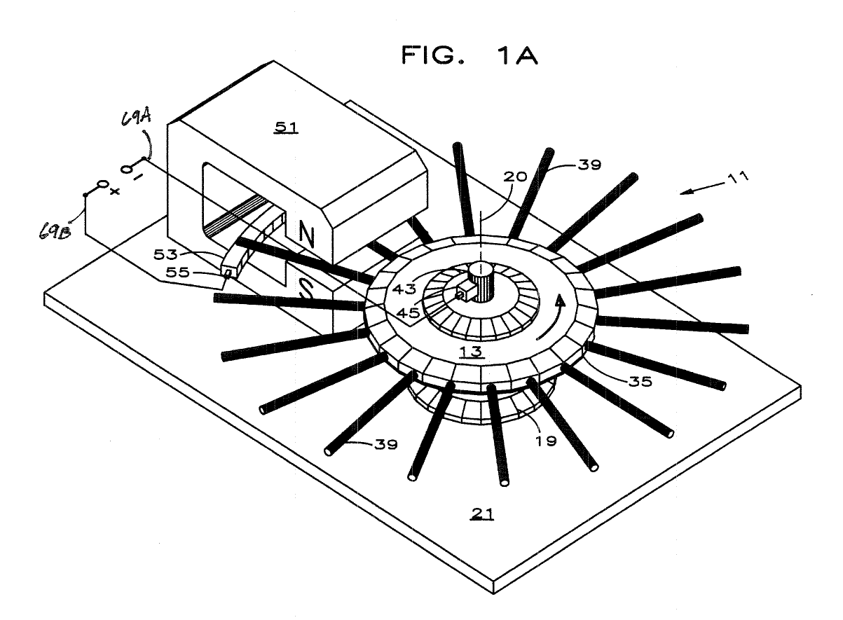

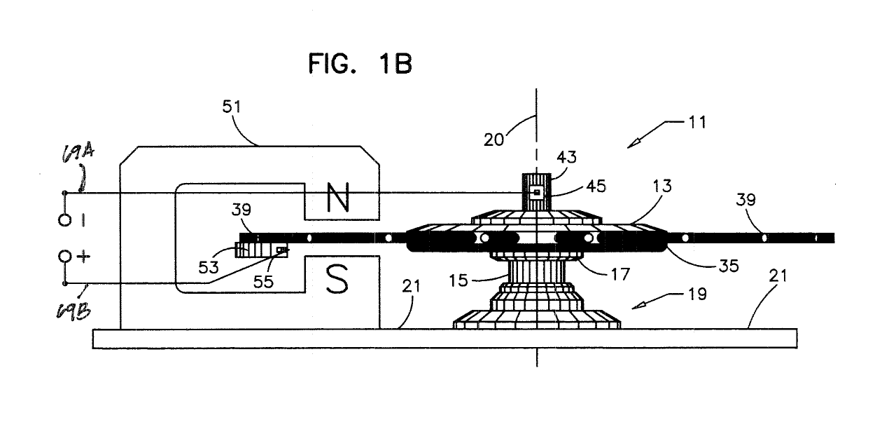

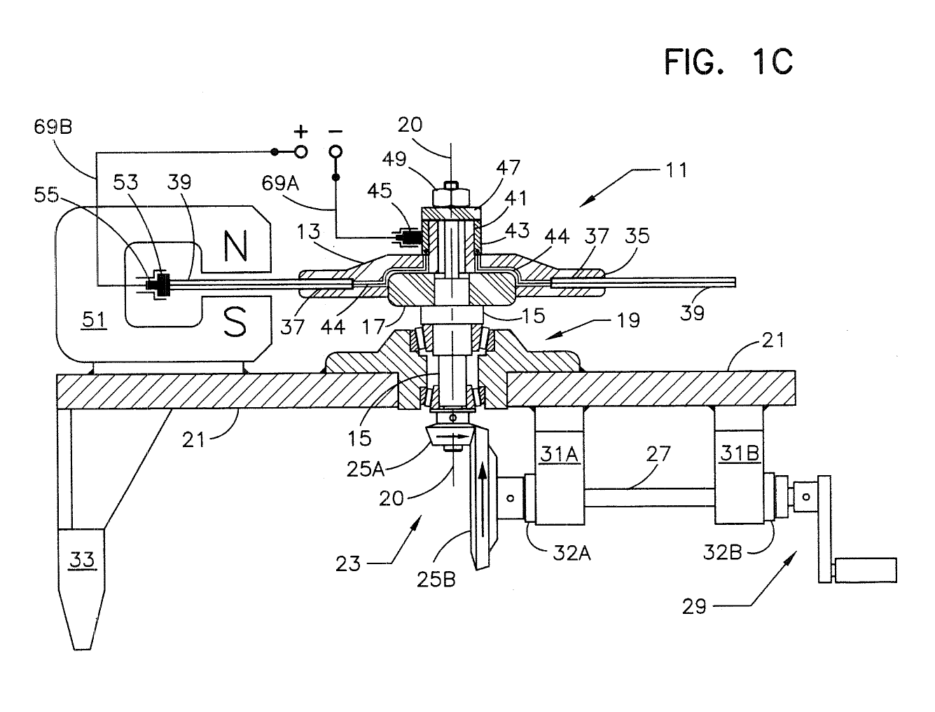

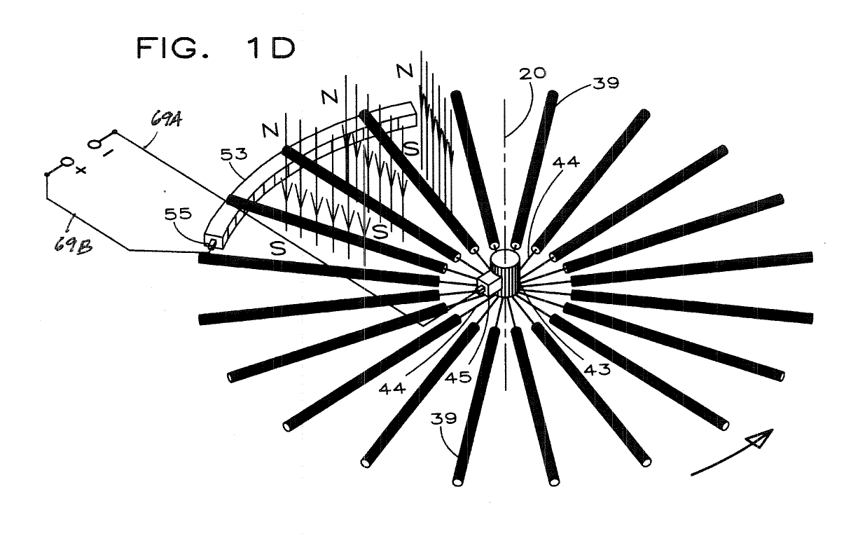

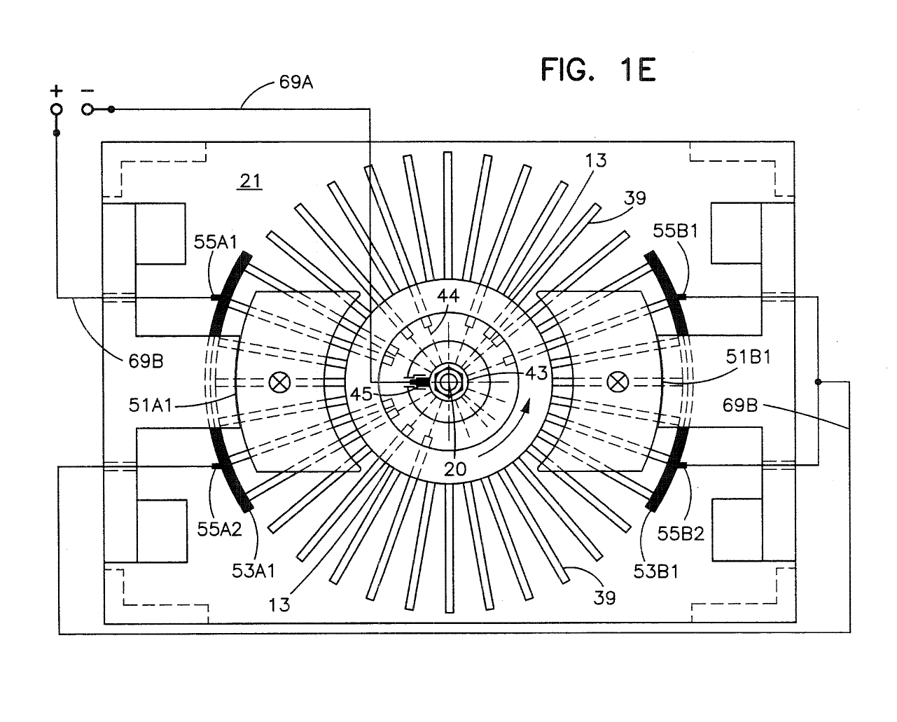

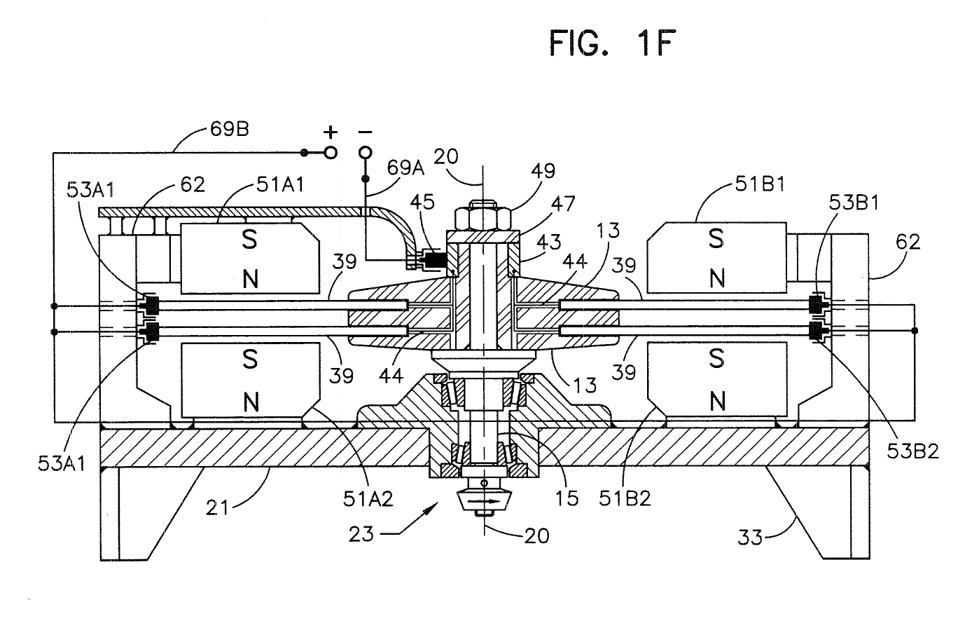

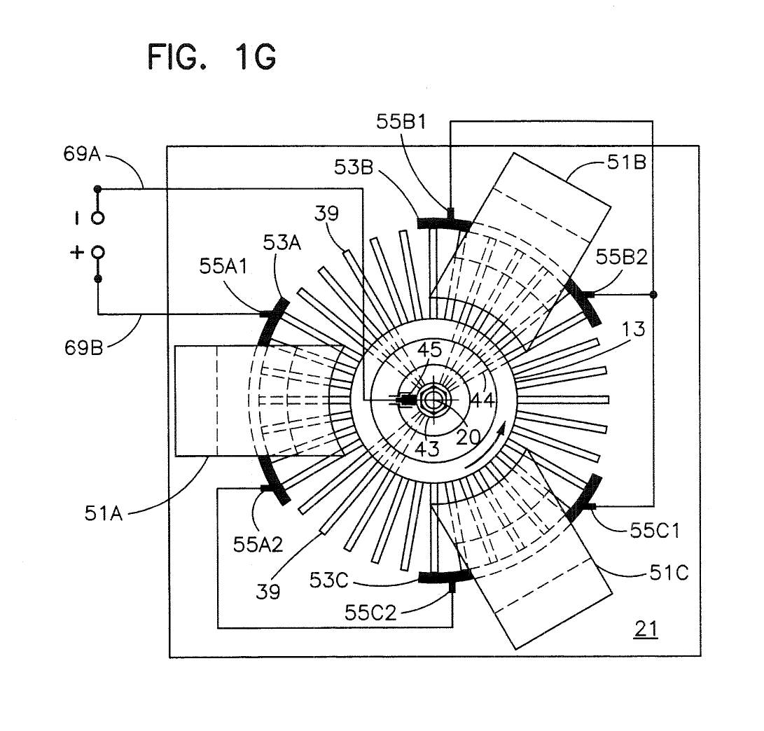

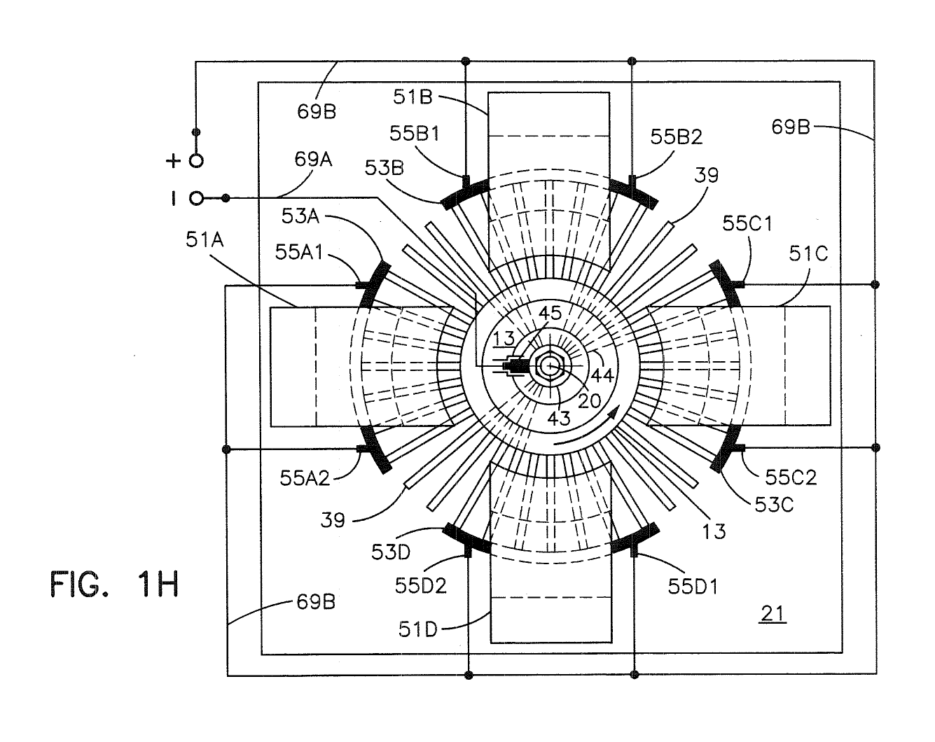

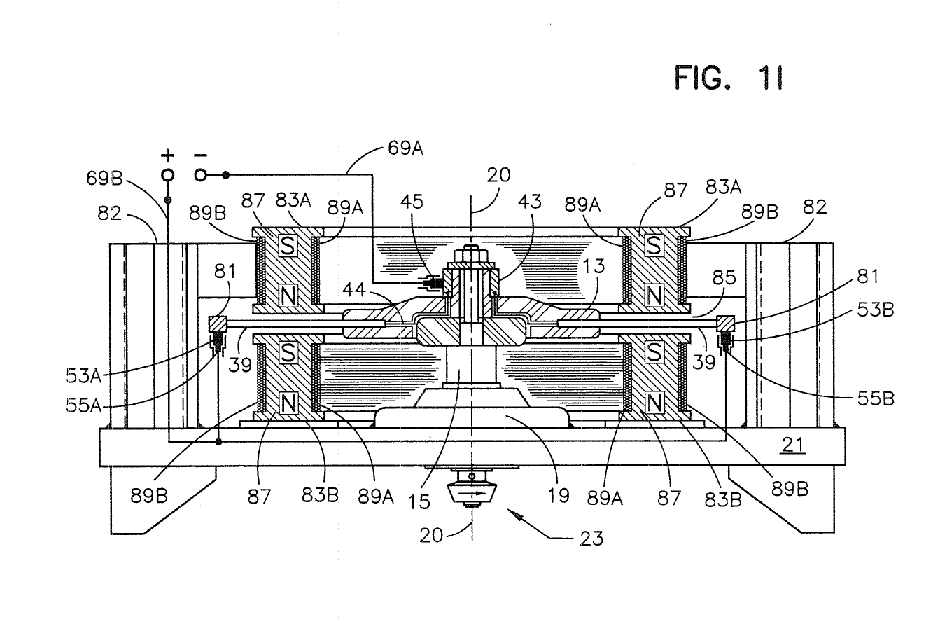

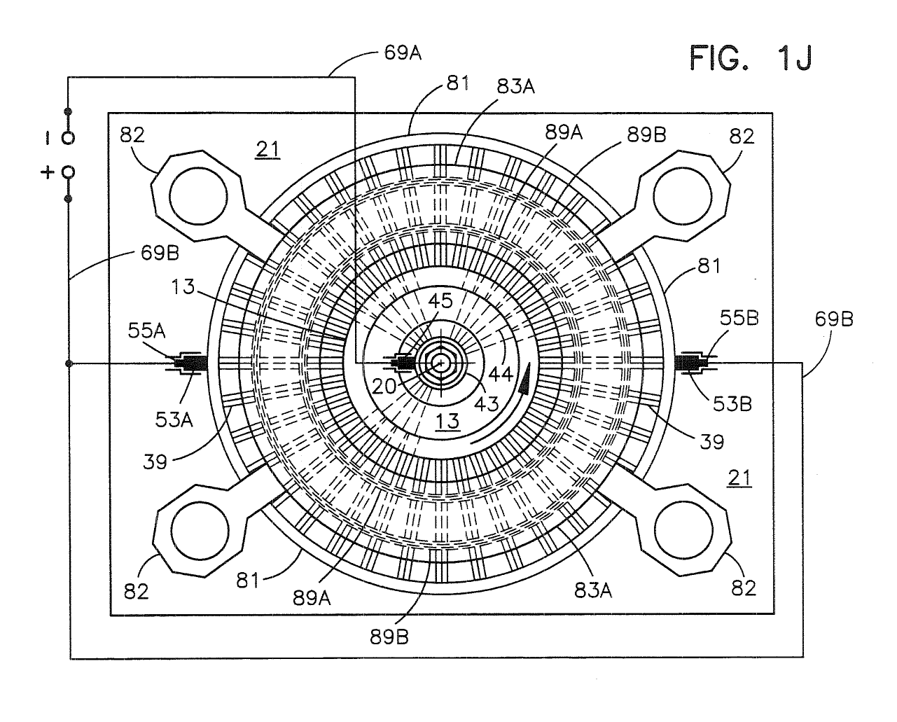

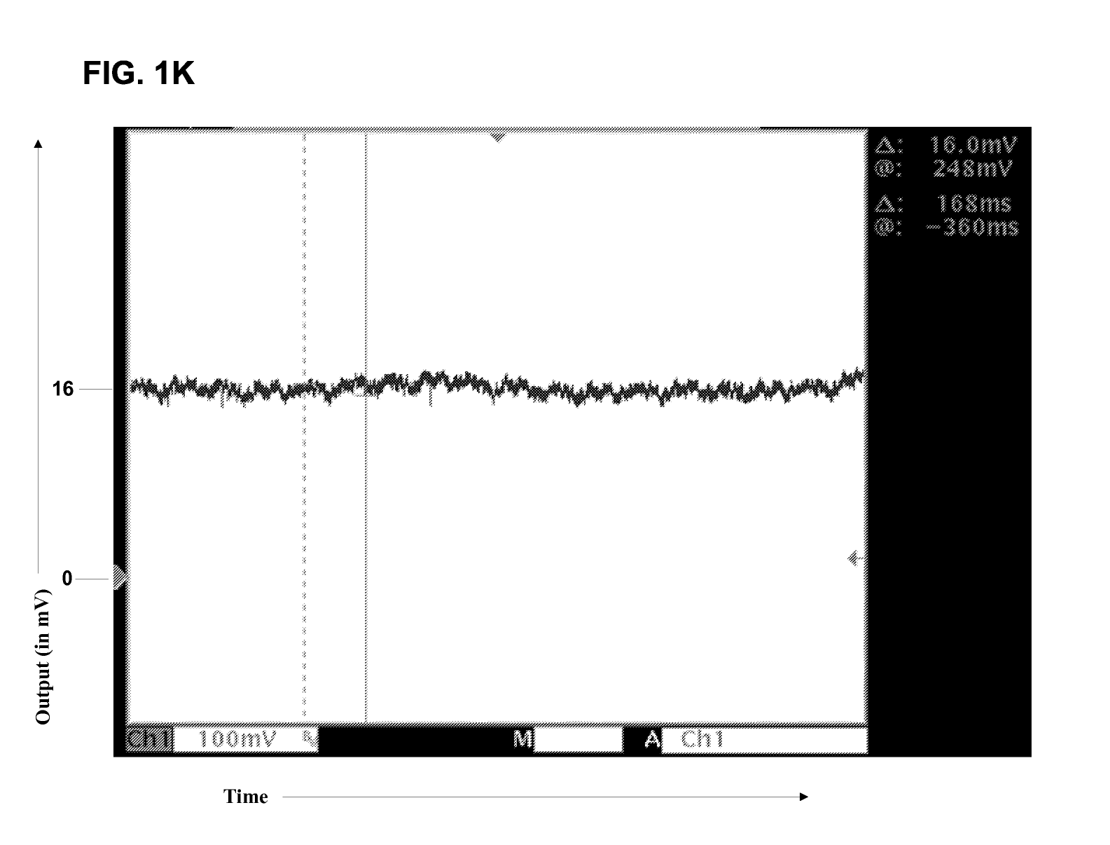

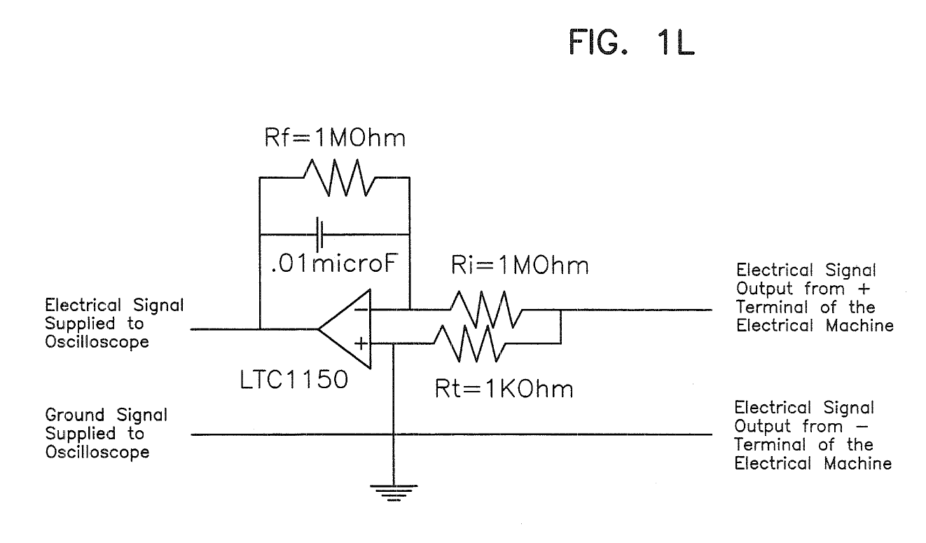

FIGS. 1A to 1D illustrate a first embodiment of an electrical machine according to the present application. The electrical machine 11 includes a carousel 13 of a dielectric or nonconductive material (such as composites include graphite composites, nylon, Teflon or other plastic material or combinations of them) that is fixed to a rotating shaft 15 by a spline 17 or other suitable interface. Alternatively, the carousel 13 can be realized from a conductive material (e.g., metal or alloy of metals) if the conductive rods 39 as described below are wrapped in a non-conductive sleeve for isolation. The shaft 15 is supported in a vertical orientation by a bearing assembly 19 that is mounted to a thru-hole in a support platform 21. The bearing assembly 19 supports the shaft 15 while allowing for rotation of the shaft 15 about a rotational axis 20. Alternatively, the shaft 15 can be set stationary and the carousel 13 can be set rotatable, while the bearings assembly can be bronze, slide bearings.

As best shown in FIG. 1C, a drive assembly 23 is mated to bottom end of the shaft 15. The drive assembly 23 is operated to drive the rotation of the shaft 15. In the illustrative embodiment, the drive assembly 23 includes a set of bevel gears 25A, 25B with a shaft 27 that is rotational driven by a hand crank 29. The bevel gears 25A, 25B and the shaft 27 and the hand crank 29 are mounted to the support platform 21 by a pair of pillars 31A, 31B that is welded or otherwise secured to the underside of the support platform 21. The pillars 31A, 31B extend downward and directly support the shaft 27 via bearing assemblies 32A, 32B. In the preferred embodiment, the bearing assemblies 32A, 32B are realized by flanged slide bearings of bronze material. The support platform 21 includes a number of feet (one shown as 33 in FIG. 1C) that are welded or otherwise secured to the underside of the support platform 21. The feet 33 extend downward from the support platform 21 to allow the support platform 21 to rest on a support structure (such as a table, a floor, the ground, etc.) in a manner that provides for clearance of the drive assembly 23.

As best shown in FIG. 1C, the outer edge 35 of the carousel 13 includes a plurality of (e.g., eighteen) radial holes 37 that extend radially inward toward the rotational axis 20. The radial holes 37 line in a plane perpendicular to the rotational axis 20 and all point to a central point that lies at the intersection of the plane and the rotational axis. This configuration can be defined by a two-dimensional polar coordinate system whose origin lies at this central point. In this configuration, the radial holes extend along directions whose angular coordinates are distributed about the 360° around the origin. The radial holes 37 each receive and support one end of an elongate rod 39 of solid conductive material (such as copper). In this manner, the carousel 13 supports a plurality of (e.g., eighteen) rods 39 that lie in a plane perpendicular to the rotational axis 20 and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine.

The central portion of the carousel 13 includes an annular shoulder 41. This annular shoulder 41 is a solid part of the carousel 13. A slip ring 43 of solid conductive material (such as bronze, brass or copper) is fixable mounted by press-fit about the annular shoulder 41 such that it rotates with the carousel 13 and shaft 15. As best shown in FIG. 1C, electrical conductors 44 extend between the slip ring 43 and the respective ends of rods 39 that are mated (fixed) to the carousel 13. The electrical conductors 44 can extend through the interior of the carousel 13 as shown. A stationary brush 45 (which is formed of conductive material, such as graphite) slides over the slip ring 43 and remains electrically connected to the slip ring 43 as the slip ring 43 rotates with the carousel 13 and the shaft 15. In this manner, the brush 45 is electrically connected via the conductors 44 to the ends of the conductive rods 39 that are mated (set in) to the carousel 13. A conductor 69A is electrically connected to the brush 45 to provide a first output terminal (labeled “−”) in FIGS. 1A to 1D. A washer 47 (which is preferably formed of a non-conductive or dielectric material such as nylon) and end nut 49 hold the slip ring 43 and the carousel 13 in place about the top end of the shaft 15 during operation. A permanent U-shaped magnet unit 51 is supported in a stationary position on the top side of the platform 21. The poles of the magnet unit 51 are configured to produce a static magnetic field (also commonly referred to as “magnetic flux” or “magnetic field lines of force”) whose primary direction is parallel but spaced radially apart from the rotational axis 20. The rods 39 rotate in a plane that passes through the opening of the magnet unit 51 and that lies perpendicular to the primary direction of the static magnetic field flux produced by the magnet unit 51. The dimensions (e.g., width and length) of the opposed poles of the magnet 51 are configured such that the static magnetic field's lines of force produced by the magnet unit 51 interacts with a predefined number of adjacent rods 39 (for example, three of the eighteen rods 39 in FIG. 1A) at any given rotational orientation of the rods 39 and carousel 13 as the rods 39 rotate about the rotational axis 20. A crescent-shaped or radial conductive brush 53 is supported within the interior space of the magnet 51. The brush 53 is configured to contact and electrically connect to the peripheral ends of the predefined number of adjacent rods 39 (e.g., three of the eighteen rods 39 in FIG. 1A) that interact with the magnet unit 51 as the rods 39 rotate about the rotational axis 20. A second output terminal connector 55 is electrically connected to the brush 53. A conductor 69B is electrically connected to the second output terminal connector 55 to provide a second output terminal (labeled “+”) in FIGS. 1A to 1D.

The central brush 45, the slip ring 43, the conductive wires 44, the radial rods 39, and the radial brush 53 form a circuit between the first and second output terminals (“−” and “+”) as best shown in the schematic diagram of FIG. 1D. The rotation (radial movement or “radial velocity”) of rods 39 in the plane perpendicular to the static magnetic field produced by the magnet unit 51 causes continuous and cumulative interception of the magnetic field's lines of force produced by the magnet unit 51 and induces electromotive force (emf) and concomitant continuous-mode DC voltage (or power) in the rods 39 that flows through this circuit. The electromotive force (emf) and concomitant continuous mode DC voltage is induced by the Lorentz force. Specifically, as the rods 39 move through the static magnetic field flux produced by the magnet unit 51, the current carriers in the rods 39 of the circuit experience a push that is perpendicular to both the radial velocity of the rods 39 and to the external static magnetic field produced by the magnet unit 51. The voltage level of the straight and continuous-mode DC power induced in the rods 39, is dictated primarily by the cross-sectional area, magnitude and density of the static magnetic field flux produced by the magnet unit 51, the respective lengths, cross-sectional areas and numbers of the rods 39 that intercept the static magnetic field's lines of force produced by the magnet unit 51, and the rotational speed (e.g., radial velocity) of the rods 39.

FIGS. 1E and 1F are a top and cross-section schematic view of a second embodiment of an electrical machine according to the present application. It is similar in construction and operation as to the first embodiment described above with respect to FIGS. 1A to 1D. In the second embodiment, the carousel 13 supports thirty-six pairs of rods 39 that lie in a plane perpendicular to the rotational axis 20 of the carousel 13 and extend radially outward away from the rotational axis 20 along directions whose angular coordinates are distributed about the 360° around the origin (rotational axis) as shown. The two rods for each one of the thirty six pairs extend parallel to one another and are offset vertically with respect to one another as best shown in FIG. 1F. The space between the rods 39 (and the rod pairs) is occupied by air, which acts as an electrical insulator at the intended operating conditions of the machine. The carousel 13 is preferably realized from a non-conductive material and thus provides for additional electrical isolation between the rods 39 while acting to mechanically support the rods 39 in place. It also includes two pairs of permanent magnet units 51A and 51B that are both supported at stationary positions on the top side of the platform 21 with their upper poles mounted stationary to two vertical support mounts 62 and set opposite one another with the carousel 13 therebetween. The poles of each respective magnet unit 51A and 51B are configured to produce a static magnetic field flux whose primary direction is parallel but spaced radially apart from the rotational axis 20. The static magnetic fields produced by the magnet units 51A and 51B have the same polarity and are preferably equal in magnitude. The rods 39 rotate in a plane that passes through the openings of the respective magnet units 51A and 51B and that lies perpendicular to the primary directions of the static magnetic field's lines of force produced by the magnet units 51A and 51B. The dimensions (e.g., width and length) of the opposed poles of the respective magnet units 51A and 51B are configured such that the static magnetic field produced by respective magnet units 51A, 51B interacts with a predefined number of adjacent rods 39 (for example, seven rod pairs of the thirty-six rod pairs in FIG. 1E) at any given rotational orientation of the rod pairs and carousel 13 as the rod pairs rotate about the rotational axis 20. A set of crescent-shaped (or radial) conductive brushes 53A1, 53A2, 53B1, 53B2 is supported in a position outside the respective magnet units 51A, 51B. Brushes 53A1, 53B1 are configured to contact and electrically connect to the peripheral ends of the predefined number of adjacent top rods 39 (for example, seven of the thirty six top rods 39 in FIG. 1E) that interact with the corresponding magnet units 51A, 51B as the rod pairs rotate about the rotational axis 20. Brushes 53A2, 53B2 are configured to contact and electrically connect to the peripheral ends of the predefined number of adjacent bottom rods 39 (for example, seven of the thirty six bottom rods 39 in FIG. 1F as shown) that interact with the corresponding magnet units 51A, 51B as the rod pairs rotate about the rotational axis 20. A set of output terminal connectors (four shown as 55A1, 55A2, 55B1, 55B2) are electrically connected to the brushes 53A1, 53A2, 53B1, 53B2. The output terminal connectors for the brushes 53A1, 53A2, 53B1, 53B2 are connected together (these connections could be a parallel connection as shown or possibly a series connection) and terminate at the conductor 69B of the second output terminal (+) of the electrical machine. A stationary brush 45 (which is formed of conductive materials, such as copper and graphite) slides over the slip ring 43 and remains electrically connected to the slip ring 43 as the slip ring 43 rotates with the carousel 13 and the shaft 15. In this manner, the brush 45 is electrically connected via the conductors 44 to the ends of the conductive rods 39 that are mated (set in) to the carousel 13. A conductor 69A is electrically connected to the brush 45 to provide a first output terminal (labeled “−”) in FIGS. 1E and 1F.

The brush 45, the slip ring 43, the conductors 44, the rods 39, and the brushes 53A, 53B form a circuit between the first and second output terminals (“−” and “+”). The rotation (radial movement) of rods 39 in the plane perpendicular to the static magnetic field flux produced by the magnet unit 51A causes continuous and cumulative interception of the magnetic field's lines of force produced by the magnet unit 51A and induces electromotive force (emf) and concomitant continuous-mode DC voltage in the rods 39 that flows through this circuit. Similarly, the rotation (radial movement) of rods 39 in the plane perpendicular to the static magnetic field flux produced by the magnet unit 51B causes continuous and cumulative interception of the magnetic field's lines of force produced by the magnet unit 51B and induces emf and concomitant continuous-mode DC voltage in the rods 39 that flows through this circuit. The connection of the brush connectors to the second output terminal (+) functions to sum the induced continuous-mode DC voltage signal flowing through the respective brushes 53A1, 53A2, 53B1, 53B2.

FIG. 1G is a top schematic view of a third embodiment of an electrical machine according to the present application. It is similar in construction and operation to the second embodiment described above with respect to FIGS. 1E and 1F. In the third embodiment, the carousel 13 supports thirty-six rods 39 that lie in a plane perpendicular to the rotational axis 20 of the carousel 13 and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine. It also includes three permanent U-shaped magnet units 51A, 51B, 51C that are supported at stationary positions on the top side of the platform 21 at even spacing (i.e., at 120° intervals) about the circumference of the carousel 13 with the carousel 13 disposed therebetween. The dimensions (e.g., width and length) of the opposed poles of the respective magnet units 51A, 51B, 51C are configured such that the static magnetic field produced by respective magnet units 51A, 51B, 51C interacts with a predefined number of adjacent rods 39 (for example, seven of the thirty six rods 39 in FIG. 1G) at any given rotational orientation of the rods 39 and carousel 13 as the rods 39 rotate about the rotational axis 20. Three crescent-shaped (or radial) conductive brushes 53A, 53B, 53C are supported within the interior space of the respective magnet units 51A, 51B, 51C. Each brush 53A, 53B, 53C is configured to contact and electrically connect to the peripheral ends of the predefined number of adjacent rods 39 (for example, seven of the thirty six rods 39 in FIG. 1G) that interact with the corresponding magnet units 51A, 51B, 51C as the rods 39 rotate about the rotational axis 20. One or more output terminal connectors (two shown as 55A1, 55A2) are electrically connected to the brush 53A, and one or more output terminal connectors (two shown as 55B1, 55B2) are electrically connected to the brush 53B, and one or more output terminal connectors (two shown as 55C1, 55C2) are electrically connected to the brush 53C. The output terminal connectors for the three brushes 53A, 53B, 53C are connected together (these connections could be a series connection as shown or possibly a parallel connection) and terminate at a conductor 69B for the second output terminal (+) of the electrical machine. A stationary brush 45 slides over the slip ring 43 and remains electrically connected to the slip ring 43 as the slip ring 43 rotates with the carousel 13 and the shaft 15. In this manner, the brush 45 is electrically connected via the conductors 44 to the ends of the conductive rods 39 that are mated (set in) to the carousel 13. A conductor 69A is electrically connected to the brush 45 to provide a first output terminal (labeled “−”) in FIG. 1G.

The brush 45, the slip ring 43, the conductors 44, the rods 39, and the brushes 53A, 53B, 53C form a circuit between the first and second output terminals (“−” and “+”). The rotation (radial movement) of rods 39 in the plane perpendicular to the static magnetic field flux produced by the magnet unit 51A causes continuous and cumulative interception of the magnetic field's lines of force produced by the magnet unit 51A and induces emf and concomitant continuous-mode DC voltage in the rods 39 that flows through this circuit. Similarly, the rotation (radial movement) of rods 39 in the plane perpendicular to the static magnetic field produced by the magnet unit 51B causes continuous and cumulative interception of the magnetic field's lines of force produced by the magnet unit 51B and induces emf and concomitant continuous-mode DC voltage in the rods 39 that flows through this circuit. Similarly, the radial movement of rods 39 in the plane perpendicular to the static magnetic field produced by the magnet unit 51C causes continuous and cumulative interception of the magnetic field's lines of force produced by the magnet unit 51C and induces emf and concomitant continuous-mode DC voltage in the rods 39 that flows through this circuit. The connection of the brush connectors to the second output terminal (+) functions to sum the induced continuous-mode DC voltage signal flowing through the respective brushes 53A, 53B, 53C.

FIG. 1H is a top schematic view of a fourth embodiment of an electrical machine according to the present application. It is similar in construction and operation to the second and third embodiments described above with respect to FIGS. 1E, 1F and especially 1G. In the fourth embodiment, the carousel 13 supports thirty-six rods 39 that lie in a plane perpendicular to the rotational axis 20 of the carousel 13 and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine. It also includes four permanent U-shaped magnet units 51A, 51B, 51C, 51D that are supported at stationary positions on the top side of the platform 21 at even spacing (i.e., at 90° intervals) about the circumference of the carousel 13 with the carousel 13 disposed therebetween. The dimensions (e.g., width and length) of the opposed poles of the respective magnet units 51A, 51B, 51C, 51D are configured such that the static magnetic field produced by respective magnet units 51A, 51B, 51C, 51D interacts with a predefined number of adjacent rods 39 (for example, seven of the thirty six rods 39 in FIG. 1H) at any given rotational orientation of the rods 39 and carousel 13 as the rods 39 rotate about the rotational axis 20. Four crescent-shaped (or radial) conductive brushes 53A, 53B, 53C, 53D are supported within the interior space of the respective magnet units 51A, 51B, 51C, 51D. Each brush 53A, 53B, 53C, 53D is configured to contact and electrically connect to the peripheral ends of the predefined number of adjacent rods 39 (for example, seven of the thirty six rods 39 in FIG. 1H) that interact with the corresponding magnet units 51A, 51B, 51C, 51D as the rods 39 rotate about the rotational axis 20. One or more output terminal connectors (two shown as 55A1, 55A2) are electrically connected to the brush 53A, one or more output terminal connectors (two shown as 55B1, 55B2) are electrically connected to the brush 53B, one or more output terminal connectors (two shown as 55C1, 55C2) are electrically connected to the brush 53C, and one or more output terminal connectors (two shown as 55D1, 55D2) are electrically connected to the brush 53D. The output terminal connectors for the four brushes 53A, 53B, 53C, 53D are connected together (these connections could be a parallel connection as shown or possibly a series connection) and terminate at conductor 69B for the second output terminal (+) of the electrical machine. A stationary brush 45 slides over the slip ring 43 and remains electrically connected to the slip ring 43 as the slip ring 43 rotates with the carousel 13 and the shaft 15. In this manner, the brush 45 is electrically connected via the conductors 44 to the ends of the conductive rods 39 that are mated (set in) to the carousel 13. A conductor 69A is electrically connected to the brush 45 to provide a first output terminal (labeled “−”) in FIG. 1H.

The brush 45, the slip ring 43, the conductors 44, the rods 39, and the brushes 53A, 53B, 53C, 53D form a circuit between the first and second output terminals (“+” and “−”). The rotation (radial movement) of rods 39 in the plane perpendicular to the static magnetic field produced by the magnet unit 51A causes continuous and cumulative interception of the magnetic field's lines of force produced by the magnet unit 51A and induces emf and concomitant continuous-mode DC voltage in the rods 39 that flows through this circuit. Similarly, the rotation (radial movement) of rods 39 in the plane perpendicular to the static magnetic field produced by the magnet unit 51B causes continuous and cumulative interception of the magnetic field's lines of force produced by the magnet unit 51B and induces emf and concomitant continuous-mode DC voltage in the rods 39 that flows through this circuit. Similarly, the rotation (radial motion) of rods 39 in the plane perpendicular to the static magnetic field produced by the magnet unit 51C causes continuous and cumulative interception of the magnetic field's lines of force produced by the magnet unit 51C and induces emf and concomitant continuous-mode DC voltage in the rods 39 that flows through this circuit. Similarly, the rotation (radial movement) of rods 39 in the plane perpendicular to the static magnetic field produced by the magnet unit 51D causes continuous and cumulative interception of the magnetic field's lines of force produced by the magnet unit 51D and induces emf and concomitant continuous-mode DC voltage in the rods 39 that flows through this circuit. The connection of the brush connectors to the second output terminal (+) functions to sum the induced continuous-mode DC voltage signal flowing through the respective brushes 53A, 53B, 53C, 53D.

FIGS. 1I and 1J are sectional and top schematic views, respectively, of a fifth embodiment of an electrical machine according to the present application. It is similar in construction and operation to the first embodiment described above with respect to FIGS. 1A to 1D. In the fifth embodiment, the carousel 13 supports thirty-six rods 39 that lie in a plane perpendicular to the rotational axis 20 of the carousel 13 and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine. The outer peripheral ends of the rods 39 are joined, fastened or otherwise secured to a ring member 81 realized from a solid conductive material such bronze, brass or possibly copper. Instead of U-shaped permanent magnet units, a pair of cylinder-shaped electro-magnets magnets 83A, 83B (or segmented cylinder pairs) is supported by mounts 82 at stationary positions on the top side of the platform 21 with a gap 85 therebetween. This pair of cylinder-shaped electro-magnets 83A, 83B (or segmented cylinder pairs) is supported at stationary positions on the top side of the platform 21 with the gap 85 therebetween. The rods 39 rotate in a plane that passes through the gap 85. The cylinder-shaped electro-magnet 83A is supported by mounts 82 in a fixed position above the plane of the rods 39. The cylinder-shaped electro-magnet 83B is supported by the top surface of the platform 21 in a fixed position opposite the cylinder-shaped electro-magnet 83A below the plane of the rods 39. Each respective cylinder-shaped electro-magnet has an annular core 87 that supports an inner winding 89A disposed along the inner annular sidewall of the core 87 and an outer winding 89B disposed along the outer annular sidewall of the core. Each loop of both the inner and outer windings 89A, 89B extend in a (radial) plane substantially perpendicular to the rotational axis 20. In this configuration, both the inner winding 89A and outer winding 69B extend along a respective annular sidewall of the core 87 in a direction parallel to the rotational axis 20 as best shown in FIG. 1I. The loops of the winding 89A are configured to carry DC current in a (radial) counterclockwise sense, and the loops of the winding 89B are configured to carry DC current in a (radial) clockwise sense. These current directions produce the magnetic poles of a static magnetic field flux, whose primary direction is parallel but spaced apart from the rotational axis 20 about the full peripheral circumference of the carousel 13. The rotational plane of the rods 39 lies perpendicular to the primary direction of the static magnetic field lines of force produced by the cylinder-shaped electro-magnets 83A, 83B as shown. The annular configuration of the opposed poles of the respective cylinder-electro-magnets 83A and 83B produces a static magnetic field flux that interacts with all of the rods 39 as the rods 39 rotate about the rotational axis 20. Similar to the first embodiment as described above, the central portion of the carousel 13 supports a slip ring 43 that rotates with the carousel 13. The rods 39 rotate in a plane that passes through the gap 85. The magnetic poles of the respective cylinder-shaped magnets 83A and 83B are configured to produce a static magnetic field flux, whose primary direction is parallel but spaced radially apart from the rotational axis 20 about the full circumference of the carousel 13. The rotational plane of the rods 39 lies perpendicular to the primary direction of the static magnetic field lines of force produced by the cylinder-shaped electro-magnets 83A and 83B. The annular configuration of the opposed poles of the respective magnets 83A and 83B produces a static magnetic field flux that interacts with all of the rods 39 as the rods 39 rotate about the rotational axis 20. One or more conductive brushes (for example, two shown as 53A and 53B) are configured to contact and electrically connect to the ring member 81 as the ring member 81 and rods 39 rotate about the rotational axis 20. Output terminal connectors 55A, 55B are electrically connected to the respective brush(es) 53A, 53B and connected together (for example, by parallel connection) and terminate at conductor 69B of the second output terminal (+) of the machine. A stationary brush 45 slides over the slip ring 43 and remains electrically connected to the slip ring 43 as the slip ring 43 rotates with the carousel 13 and the shaft 15. In this manner, the brush 45 is electrically connected via the conductors 44 to the ends of the conductive rods 39 that are mated (set in) to the carousel 13. A conductor 69A is electrically connected to the brush 45 to provide a first output terminal (labeled “−”) in FIGS. 1I and 1J.

The brush 45, the slip ring 43, the conductors 44, the rods 39, the ring member 81 and the brushes 53A, 53B form a circuit between the first and second output terminals (“−” and “+”). The rotation (radial movement) of rods 39 in the plane perpendicular to the static magnetic field flux produced by the cylinder-shaped electro-magnets 83A, 83B causes continuous and cumulative interception of the magnetic field lines of force produced by the cylinder-shaped magnets 83A, 83B and induces electromotive force (emf) and concomitant continuous-mode DC voltage in the rods 39 that flows through this circuit.

It is also contemplated that the opposed cylinder-shaped magnets 83A, 83B can be realized by multiple magnet units (which can be permanent magnets and/or electromagnets as described herein). For example, one cylinder-shaped electro-magnet can be placed inside another cylinder-shaped electro-magnet similar to the way you can have one circle or ring inside another. This configuration can be useful for strengthening the overall magnetic field flux for large generators or motors. It is also to be noticed that cylinder-electro-magnet pair type, allows effectively to place inside an inner central carousel rotating system to spin the rods' conductors with its mechanism of rotation and a central slip-ring-brush system.

FIG. 1K is a signal trace that illustrates an example of the continuous-mode DC voltage signal produced by the electrical machine embodiments of FIGS. 1A to 1J. The continuous-mode DC voltage signal output by the machine generally has a relatively constant DC voltage of positive polarity when the output of the machine is coupled to a fixed-value resistive load (or which output is recordable and measurable by electrical meters). In this example, the continuous-mode DC voltage signal output from the “+” and “−” terminals of the machine is measured on an oscilloscope. The continuous-mode DC voltage signal output from the “+” terminal of the machine is conditioned by an integrating filter as shown in FIG. 1L. The integrating filter minimizes the brush noise. The ratio of the resistance Rf/Ri dictates the gain of the integrating filter. In this configuration, Rf/Ri is one, and thus unity gain is provided. The resistance Rt of 1 kOhm provides a resistive load to the machine. In the example shown, an embodiment similar that of FIG. 1A to 1D with eighty conductive copper rods 39 of one-quarter inch (φ¼″) in diameter that interact with two side-by-side U-shaped permanent magnets (each realized from an Alnico iron alloy of 130 pound lifting capacity) produces a continuous-mode DC voltage signal having a DC voltage level on the order of 16.0 mV at a DC current level of 16 μA in response to hand-cranking of the drive system 23 of FIG. 1C.

The straight, continuous-mode DC voltage signal produced by electrical machine embodiments of FIGS. 1A to 1J is produced because the orientation of the magnetic field's flux, of the respective permanent magnet(s) is perpendicular to the plane of radial rotation of the current generating rods. At the same time, the rods as the current generating elements have the capacity to rotate radially within a plane perpendicular to the magnetic field(s) lines of force. The orientation and condition of the magnetic field(s) lines of force and the rotational plane of the radial rods being set perpendicular to each other results in the continuous, cumulative interaction between the magnetic field(s) flux(s) and the current generating rods, which produces the continuous-mode DC voltage signal. Current produced in this manner has the characteristics of currents produced by chemical means in batteries and voltaic cells. This continues-mode DC is obtained through direct mechanical conversion in the radial-perpendicular phenomenon of the radial rotational motion in the efficient perpendicularity condition of the high density magnetic field's flux through cumulative rotational action, into dense, straight electrical energy.

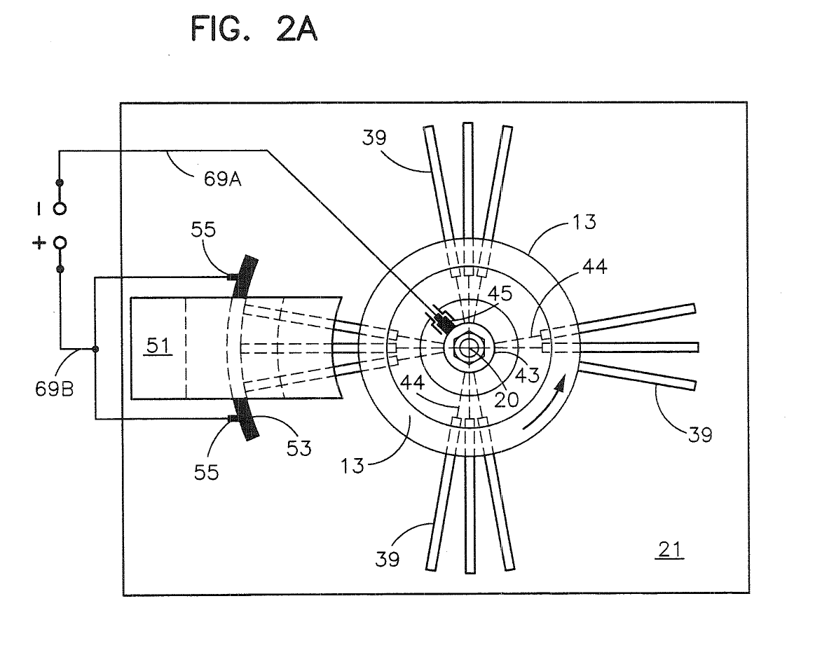

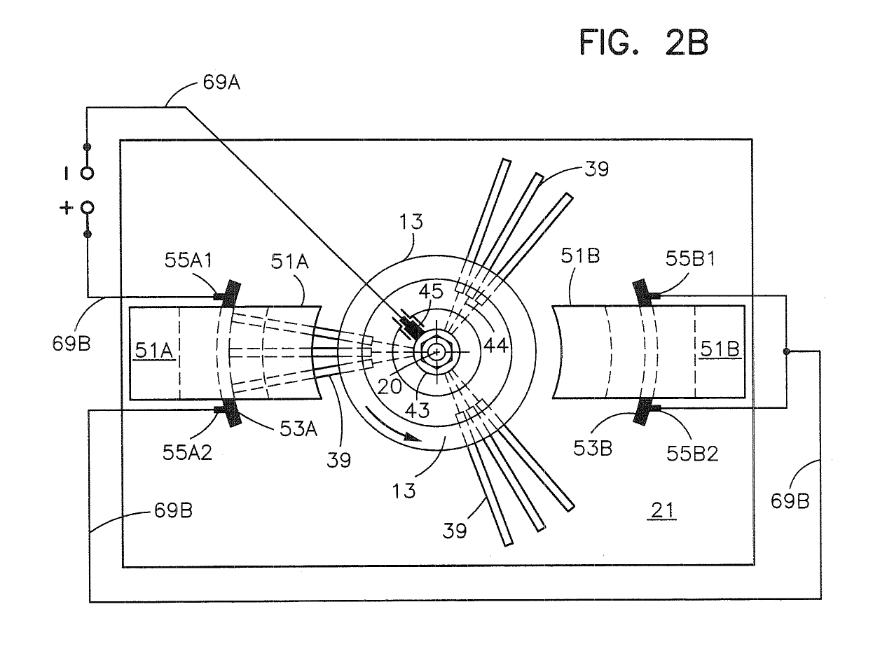

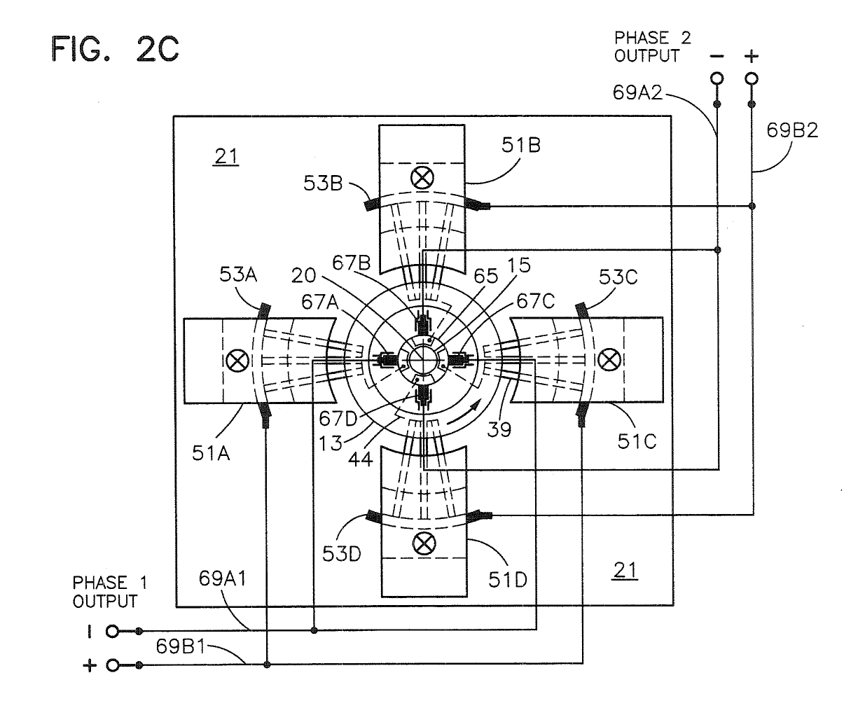

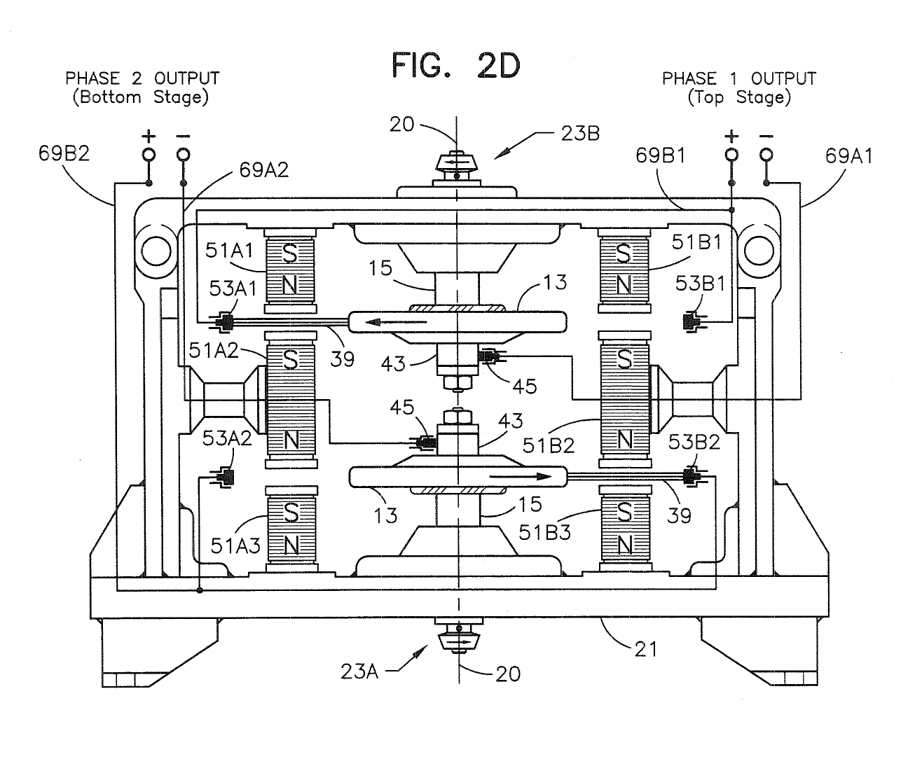

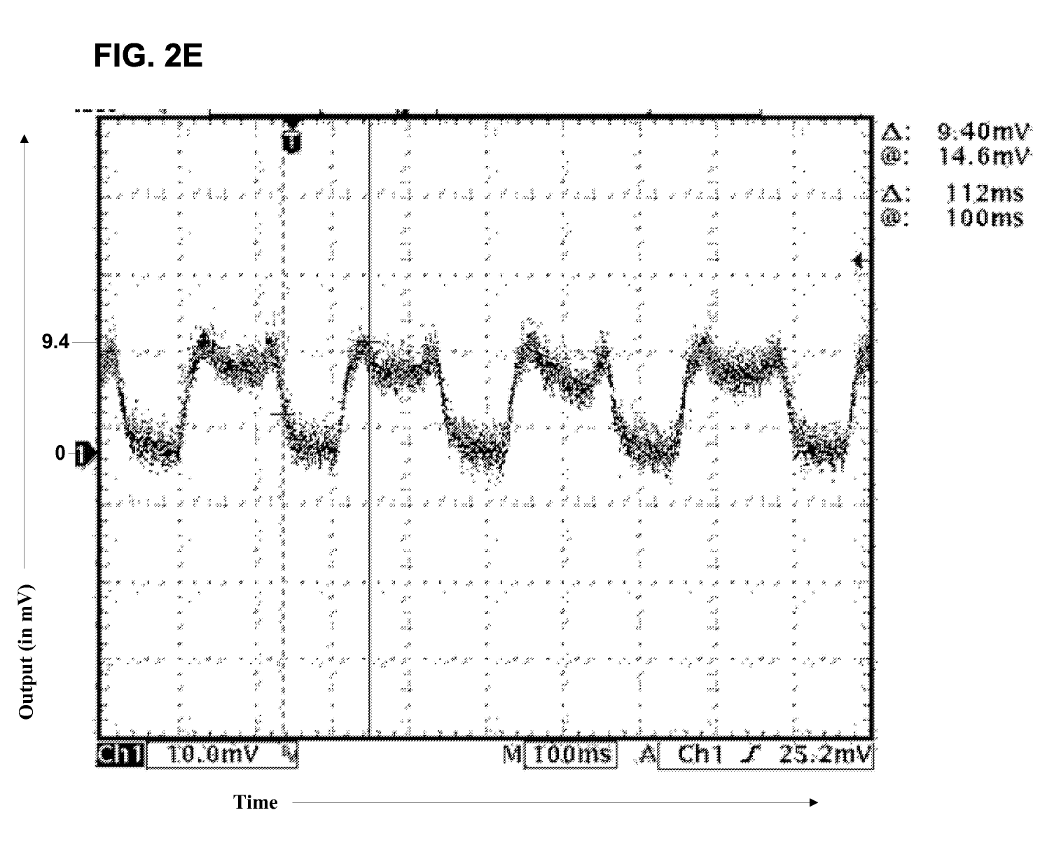

FIG. 2A is a top schematic view of a sixth embodiment of an electrical machine according to the present application. It is similar in construction and operation to the first embodiment described above with respect to FIGS. 1A to 1D. In the sixth embodiment, the carousel 13 supports twelve rods 39 (i.e., four groups of rods 39 with the groups spaced every 90° about the rotational axis 20) that lie in a plane perpendicular to the rotational axis 20 of the carousel 13 and extend radially outward away from the rotational axis 20 along directions whose angular coordinates are distributed about the 360° around the origin (rotational axis 20) as shown. The space between the rods 39 is occupied by air, which acts as an electrical insulator at the intended operating conditions of the machine. It also includes a permanent U-shaped magnet unit 51 that is supported in a stationary position on the top side of the platform 21 adjacent the carousel 13. The poles of the magnet unit 51 are configured to produce a static magnetic field flux whose primary direction is parallel but spaced radially apart from the rotational axis 20. The four groups of rods 39 rotate in a plane that passes through the opening between the magnetic poles of the magnet unit 51 and that lies perpendicular to the primary direction of the static magnetic field's lines of force produced by the magnet unit 51. The dimensions (e.g., width and length) of the opposed poles of the magnet unit 51 are configured such that the static magnetic field produced by the magnet unit 51 interacts with each respective group of rods (i.e., the three rods of each one of the four groups) as the rods 39 rotate about the rotational axis 20. A crescent-shaped conductive brush 53 is supported within the interior space of the magnet unit 51. The brush 53 is configured to contact and electrically connect to the peripheral ends of the respective groups of rods (the three rods of each one of the four groups) that interact with magnet unit 51 as the rods 39 rotate about rotational axis 20. Such brush connection is outside the magnetic field flux of the magnet unit 51. One or more output terminal connectors (two shown) are electrically connected to the brush 53. The output terminal connector(s) for the brush 53 is(are) connected together (for example, by parallel connection) and terminates at conductor 69B of the second output terminal (+) of the electrical machine. A conductor 69A is electrically connected to the brush 45 to provide a first output terminal (labeled “−”) in FIG. 2A.

In the sixth embodiment of FIG. 2A, the spacing of the rods 39 about the circumference of the carousel 13 is staggered such that as the rods 39 rotate about the rotational axis 20, there are rotational intervals of the rods 39 and carousel 13 where there are no rods that interact with the magnetic field produced by the magnet unit 51 while contacting the brush 53. In this staggered configuration, there is no DC voltage signal induced during such rotational intervals (as the circuit is broken). In this manner, the rotation of the rods 39 in the plane perpendicular to the static magnetic field flux produced by the magnet unit 51 causes a cyclical (ON/OFF) interception of the magnetic field and induces electromotive force (emf) and concomitant interrupted-mode DC voltage in the rods 39 that flows between the output terminals (−) and (+). Note that in the configuration of FIG. 2A, there are four sets of staggered rods 39 with each set having three rods. The four groups of rods are staggered about the four quadrants of the circumference of the carousel 13 as shown.

FIG. 2B is a top schematic view of a seventh embodiment of an electrical machine according to the present application. It is similar in construction and operation to the sixth embodiment as described above. In the seventh embodiment, the carousel 13 supports nine rods 39 (i.e., three groups of rods 39 with the groups spaced every 120° about the rotational axis 20) that lie in a plane perpendicular to the rotational axis 20 of the carousel 13 and extend radially outward away from the rotational axis 20 along directions whose angular coordinates are distributed about the 360° around the origin (rotational axis 20) as shown. The space between the rods 39 is occupied by air, which acts as an electrical insulator at the intended operating conditions of the machine. It also includes two permanent U-shaped magnet units 51A, 51B that are supported in stationary positions on the top side of the platform 21 on opposite sides of the carousel 13. The poles of each respective magnet unit 51A and 51B are configured to produce a static magnetic field flux, whose primary direction is parallel but spaced radially apart from the rotational axis 20. The static magnetic fields produced by the magnets 51A and 51B have the same polarity and are preferably equal in magnitude. The three groups of rods 39 rotate in a plane that passes through the openings between the poles of the magnet units 51A and 51B and that lies perpendicular to the primary directions of the static magnetic fields flux produced by the magnet units 51A and 51B. The dimensions (e.g., width and length) of the opposed poles of the respective magnet units 51A and 51B are configured such that the static magnetic field's lines of force produced by respective magnet units 51A, 51B interacts with the respective groups of adjacent rods (i.e., the three adjacent rods for each one of the three groups) as the rods 39 rotate about the rotational axis 20. A pair of crescent-shaped conductive brushes 53A, 53B is supported within the interior space of the respective magnet units 51A, 51B. Each brush 53A, 53B is configured to contact and electrically connect to the peripheral ends of the respective groups of adjacent rods (i.e., the three adjacent rods for each one of the three groups) that interact with the corresponding magnet units 51A, 51B as the rods 39 rotate about the rotational axis 20. Such brush connections are outside the magnetic field flux of the magnet units 51A, 51B. One or more output terminal connectors (two shown) are electrically connected to the brush 53A, and one or more output terminal connectors (two shown) are electrically connected to the brush 53B. The output terminal connectors for the two brushes 53A, 53B are connected together and terminate at conductor 69B for the second output terminal (+) of the machine. A conductor 69A is electrically connected to the brush 45 to provide a first output terminal (labeled “−”) in FIG. 2B.

In the seventh embodiment of FIG. 2B, the spacing of the rods 39 about the circumference of the carousel 13 is staggered such that as the rods 39 rotate about the rotational axis, there are rotational intervals of the rods 39 and carousel 13 where there are no rods that interact with the magnetic field's lines of force produced by the magnet unit 51A while contacting the brush 53A and where there are no rods that interact with the magnetic field's lines of force produced by the magnet unit 51B while contacting the brush 53B. The groups of rods 39 staggered every 120° about the periphery of the carousel 13 operate in conjunction with the two opposite magnets' unit (either one 51A or 51B) such that as one group of rods 39 passes through the magnetic flux of one of two opposite magnets' unit (either one 51A or 51B), an empty perimeter interval of the carousel 13 is aligned with the another magnet unit (and thus no rods pass the other magnet unit, and vice versa. Such operations provide synchronous appearance and decay (disappearance) of the voltage in the rods 39 and machine's output circuit. In this staggered configuration, there is no DC voltage signal induced by the magnetic fields during such rotational time intervals (as the circuit is broken). In this manner, the rotation of the rods 39 in the plane perpendicular to the static magnetic fields produced by the magnet units 51A, 51B causes a cyclical (ON/OFF) interception of the such magnetic fields and induces emf and concomitant interrupted-mode DC voltage in the rods 39 that flows between the output terminals (−) and (+). Note that in the configuration of FIG. 2B, there are three groups of staggered rods 39 with each group having three rods. The three groups of rods are spaced at 120° intervals about the circumference of the carousel 13 as shown.

FIG. 2C is a top schematic view of an eight embodiment of an electrical machine according to the present application. It is similar in construction to the sixth embodiment as described above. In the eighth embodiment, the carousel 13 supports twelve rods 39 (i.e., four groups of rods 39 with the groups spaced every 90° about the rotational axis 20) that lie in a plane perpendicular to the rotational axis 20 of the carousel 13 and extend radially outward away from the rotational axis 20 along directions whose angular coordinates are distributed about the 360° degrees around the origin (rotational axis) as shown. The space between the rods 39 is occupied by air, which acts as an electrical insulator at the intended operating conditions of the machine. It also includes a four permanent U-shaped magnet units 51A, 51B, 51C, 51D that are supported in stationary positions on the top side of the platform 21 with even spacing (i.e., at 90° intervals) about the circumference of the carousel 13. Particularly, the magnet units 51A and 51C are disposed on opposite sides of the carousel 13, and the magnet units 51B and 51D are disposed on opposite sides of the carousel 13. The poles of each respective magnet unit 51A, 51B, 51C, 51D are configured to produce a static magnetic field flux whose primary direction is parallel but spaced radially apart from the rotational axis 20. The static magnetic field lines of force produced by the magnet units 51A and 51C as a first pair, have one polarity (for example, into the page as noted by the label [symbol] ) and are preferably equal in magnitude. The static magnetic field lines of force produced by the magnet units 51B and 51D as a second pair, have the same polarity as the first pair (for example, in to the page as noted by the label [symbol] ) and are preferably equal in magnitude. The rods 39 rotate in a plane that passes through the openings between the poles of the magnets units 51A, 51B, 51C, 51D and that lies perpendicular to the primary directions of the static magnetic fields flux produced by the magnet units 51A, 51B, 51C, 51D. The dimensions (e.g., width and length) of the opposed poles of the respective magnet units 51A, 51B, 51C, 51D are configured such that the static magnetic fields flux produced by respective magnet units 51A, 51B, 51C, 51D interact at the same moment with all four respective groups of adjacent rods 39 (for example, the three rods in each one of the four groups) as the rods 39 rotate about the rotational axis 20. Four crescent-shaped conductive brushes 53A, 53B, 53C, 53D are supported within the interior space of the respective magnet units 51A, 51B, 51C, 51D. Each brush 53A, 53B, 53C, 53D is configured to contact and electrically connect to the peripheral ends of the respective four groups of adjacent rods 39 (the three rods in each one of the four groups) that instantly interact at the same time with the corresponding magnet units 51A, 51B, 51C, 51D as the rods 39 rotate about the rotational axis 20. Such brush connections are outside the magnetic field flux of the magnet units 51A, 51B, 51C, 51D. A commutator element 65 replaces the slip ring and is fixed to the top end of the shaft 15 such that it rotates with the shaft 15 while also providing connectivity to the four adjacent groups of rods 39. The commutator element 65 is constructed according to a logical partitioning of the 360° rotational movement of the carousel 13 and includes four predefined and non-overlapping sectors (connecting sectors) that are connected by conductors 44 to the four corresponding groups of rods as well as four predefined and non-overlapping disconnecting sectors interposed between the connecting sectors. During certain predefined rotational intervals of the carousel 13, the connecting sectors of the commutator 65 are configured to provide for electrical connection between the brushes 67A, 67C and the conductors 44 for the corresponding groups of rotating rods (i.e., the group at 9 o'clock and the group at 3 o'clock). In other predefined rotational intervals of the carousel 13, the connecting sectors of the commutator 65 are configured to provide for electrical connection between the brush pairs 67B, 67D and the conductors 44 for the two other opposed groups of rotating rods (i.e., the group at 12 o'clock and the group at 6 o'clock). Synchronously, for time periods between these four rotational intervals (referred to herein as “empty intervals”), the disconnecting sectors of the commutator element 65 are configured to provide electrical disconnection between the brushes 67A, 67B, 67C, 67D for all of the groups of rotating rods. One or more output terminal connectors (one shown) are electrically connected to each respective brush 53A, 53B, 53C, 53D, 67A, 67B, 67C, 67D. The electrical machine outputs two interrupted-mode DC voltage signals from the output terminals for two phases. For one phase, the output terminals for the commutator brushes 67A, 67C are connected together and terminate at conductor 69A1 for the first output terminal (−) of the phase 1 output of the machine. The output terminal connectors for the two brushes 53A, 53C are connected together and terminate at conductor 69B1 for the second output terminal (+) for the phase 1 output of the machine. For the other phase, the output terminals for the commutator brushes 67B, 67D are connected together and terminate at conductor 69A2 for the first output terminal (−) for the phase 2 output of the machine, and the output terminal connectors for the two brushes 53B, 53D are connected together and terminate at conductor 69B2 for the second output terminal (+) for the phase 2 output of the machine.

In the eighth embodiment of FIG. 2C, the staggered spacing of the rods 39 about the circumference of the carousel 13 and the configuration of the commutator element 65 dictates that the circuit is broken during the empty intervals of the commutator element 65 such that there is no DC voltage induced by the magnetic fields of the respective magnet units 51A, 51B, 51C, 51D. In this manner, the rotation of the four groups of rods 39 in the plane perpendicular to the static magnetic fields produced by the magnet units 51A, 51B, 51C, 51D causes a cyclical (ON/OFF) interception of the such magnetic fields and induces electromotive forces (emf) and concomitant interrupted-mode DC voltages in the rods 39, instantaneous in two synchronous phases that flows between the output terminals (−) and (+) of the respective phase 1 and phase 2 outputs. Note that in the configuration of FIG. 2C, there are four sets of staggered rods 39 with each set having three rods. The four sets of rods are staggered about the quadrants of the carousel 13 as shown (i.e. at every 90° interval). The electrical machine outputs instantaneously two synchronous interrupted-mode DC voltage signals from the output terminals for two phases. The polarities of the interrupted-mode DC voltage signals for the two phases are equal to one another due to the common polarity of the magnet unit pairs 51A/51C and 51B/51D. The interruptions (null voltage and current) of the interrupted-mode DC voltage signals of the two phases occur during the empty intervals of the commutator element 65. The relative timing of the interruptions (null voltage and current) of the interrupted-mode DC voltage signals for the two phases are synchronized to one another. Alternatively, the eight embodiments of the electrical machine could be easily modified to obtain two-phase with 90° out of phase voltage by eliminating two opposite groups of rods (i.e. sets at 12 and 6 o'clock position). Then the machine will output two-phase 90° out of phase interrupted-mode DC voltage. Therefore, is also easy to observe that this type of the embodiment of the electrical machine can provide four phases system as well; under the conditions that one single phase will be assign to the each of the magnet's unit. Simultaneously, the interrupted-mode DC voltages in two (or more) phases can be combined together in one phase, thanks to its instantaneous and synchronous outputs.

FIG. 2D illustrates a ninth embodiment of an electrical machine according to the present invention. It is a multi-stage design that employs two independent carousels 13 (one driven by an assembly integral to the base of the platform, and another driven by an assembly integral to a top frame). The rotational axes for the two carousels 13 are aligned to one another. The two carousels 13 can rotate in opposite directions as shown (or possibly in the same rotational direction). In the event that the two carousels 13 rotate in opposite directions, the voltage and current polarity of the electrical output phases for each stage will be opposite one another, which makes it possible to create multiple phases (depending on the number of stages) of an alternating dual-polarity voltage and current output signal by adequately combining the multiple phases. The machine also includes corresponding pairs of electro-magnets (51A1/51A2 and 51B1/51B2; 51A2/51A3 and 51B2/51B3) that are supported at stationary positions on the top side of the platform 21 opposite one another with the respective carousels 13 therebetween. The stationary positions of the electro-magnets 51A1 and 51B1 are disposed vertically above the stationary positions of the corresponding electro-magnets 51A2 and 51B2, and the stationary positions of the electro-magnets 51A2 and 51B2 are disposed vertically above the stationary positions of the corresponding electro-magnets 51A3 and 51B3. The poles of each respective electro-magnet pair (51A1/51A2, 51A2/51A3, 51B1/51B2, and 51B2/51B3) are configured to produce a static magnetic field whose primary direction is parallel but spaced radially apart from the rotational axes 20. The static magnetic fields flux produced by the electro-magnet pairs have the same polarity and are preferably equal in magnitude. The rods 39 that extend from the top carousel rotate in a first plane that passes through gaps between the respective electro-magnet pairs 51A1/51A2 and 51B1/51B2 similar to the configuration shown in FIG. 2B. The rods 39 that extend from the bottom carousel rotate in a second plane that passes through gaps between the respective electro-magnet pairs 51A2/51A3 and 51B2/51B3 similar to the configuration shown in FIG. 2B. The first rotational plane of the rods that extend from the top carousel is disposed vertically above the second rotational plane of the rods that extend from the bottom carousel. The dimensions (e.g., width and length) of the opposed poles of the respective electro-magnet pairs are configured such that the static magnetic fields produced by respective electro-magnet pairs interacts with groups of the rods 39 as the rods 39 and the respective carousels rotate about the rotational axis 20. A first pair of crescent-shaped conductive brushes 53A1, 53B1 is configured to mate to the peripheral ends of the groups of rods 39 (e.g., groups of three rods) that extend from the top carousel as the rods 39 rotate in the plane that passes through the gap between the electro-magnet pairs 51A1/51A2 and 51B1/51B2. A second pair of crescent-shaped conductive brushes 53A2, 53B2 is configured to mate to the peripheral ends of the groups of rods 39 (e.g., groups of three rods) that extend from the bottom carousel as the rods 39 rotate in the plane that passes through the gap between the electro-magnet pairs 51A2/51A3 and 51B2/51B3. A slip ring is electrically connected via conductors to the rods extending from the top carousel. A brush is electrically connected to the slip ring for the top carousel. This brush is connected to conductor 69A1 for the first output terminal (−) of the phase 1 output of the machine. The output terminal connectors for the brush pairs 53A1, 53B1 are connected together and terminate at conductor 69B 1 for the second output terminal (+) for the phase 1 output of the machine. A slip ring is electrically connected via conductors to the rods extending from the bottom carousel. A brush is electrically connected to the slip ring for the bottom carousel. This brush is connected to conductor 69A2 for the first output terminal (−) of the phase 2 output of the machine. The output terminal connectors for the brush pairs 53A2, 53B2 are connected together and terminate at conductor 69B2 for the second output terminal (+) for the phase 2 output of the machine.

The slip ring and brush, the conductive members, the rods, and the brushes 53A1, 53B1 for the top stage form a circuit between the first and second output terminals (“+” and “−”) of the phase 1 output. The rotation of rods 39 extending from the top carousel in the plane perpendicular to the static magnetic fields flux produced by the electro-magnetic pairs 51A1/51A2 and 51B1/51B2 causes a cyclical (ON/OFF) interception of the such magnetic fields and induces electromotive forces (emf) and concomitant interrupted-mode DC voltages in the rods 39 between the output terminals (−) and (+) of the phase 1 output, which flows in one direction (i.e. like negative) between the output terminals where such direction depends upon the rotation direction (clockwise or counterclockwise) of the carousel 13 of the top stage.

Similarly, the slip ring and brush, the conductive members, the rods, and the brushes 53A2, 53B2 for the bottom stage form a circuit between the first and second output terminals (“+” and “−”) of the phase 2 output. The rotation of rods 39 extending from the bottom carousel in the plane perpendicular to the static magnetic fields flux produced by the electro-magnetic pairs 51A2/51A3 and 51B2/51B3 causes a cyclical (ON/OFF) interception of the such magnetic fields and induces electromotive forces (emf) and concomitant interrupted-mode DC voltage in the rods 39 between the output terminals (−) and (+) of the phase 2 output, which flows in opposite direction (i.e. like positive) between the output terminals where such direction depends upon the rotation direction (clockwise or counterclockwise) of the carousel 13 of the bottom stage.

Note that other multi-stage designs can be implemented. For example, the electromagnets units systems shown in prior figures and especially the magnets units systems described in the FIG. 2B and FIG. 2C or combination of them can be used for the stages. In another example, other stacked configurations can be used, with single-phase or any multi-phase or electrically combined phases together in a parallel or serial way. For example, it is contemplated that like system can produce a long-rectangular-wave form single phase voltage by combining the two or more interrupted-mode DC phases.

FIG. 2E is a signal trace that illustrates positive polarity segments of an example of the interrupted-mode DC voltage signal produced by the circuits of FIGS. 2A to 2D (but could be also negative polarity voltage). The interrupted-mode DC voltage signal output by the machine generally has energy segments of relatively constant DC voltage of positive polarity between interruptions (intervals) of null voltage and current when the output of the machine is coupled to a fixed-value resistive load (or which output is recordable and measurable by electrical meters). In this example, the interrupted-mode DC voltage segmented signal output from the “+” and “−” terminals of the machine is measured on an oscilloscope. The interrupted-mode DC voltage segmented signal output from the “+” terminal of the machine is conditioned by an integrating filter as shown in FIG. 1L. The integrating filter minimizes the brush noise. The ratio of the resistance Rf/Ri dictates the gain of the integrating filter. In this configuration, Rf/Ri is one, and thus unity gain is provided. The resistance Rt of 1 kOhm provides a resistive load to the machine. In the example shown, an embodiment similar that of FIG. 2B with thirty six conductive coppers rods 39 of one-quarter inch in diameter (with three groups of twelve rods each spaced at 120° intervals about the circumference of the carousel 13) that interact with two opposed U-shaped permanent magnet units (each realized from an Alnico iron alloy of 130 pound lifting capacity) produces the electromotive force (emf) and concomitant interrupted-mode DC voltage segmented signal have a DC voltage level on the order of 9.0 mV at a DC current level of 9.0 μA in response to hand-cranking of the drive system.

Note that the frequency and duty cycle of the interrupted-mode DC voltage segmented signal, is dictated by the rate of rotation of the rods 39 and diameter of the carousel body 13, as well as the configuration of the rods (the number of groups and the interval spacing therebetween) and the number of magnet units with corresponding brushes, set radially around the peripheral of the carousel 13 of the electrical machine. It is also contemplated that with an extreme high frequency of the interrupted-mode current, the interrupted-waveforms become to be extremely narrow on its polarity and become converting itself to a form of pulsating energy. Then because this energy if desired can be specifically received in one, two, three or more synchronous or nonsynchronous phases may find new special scientific or practical applications.

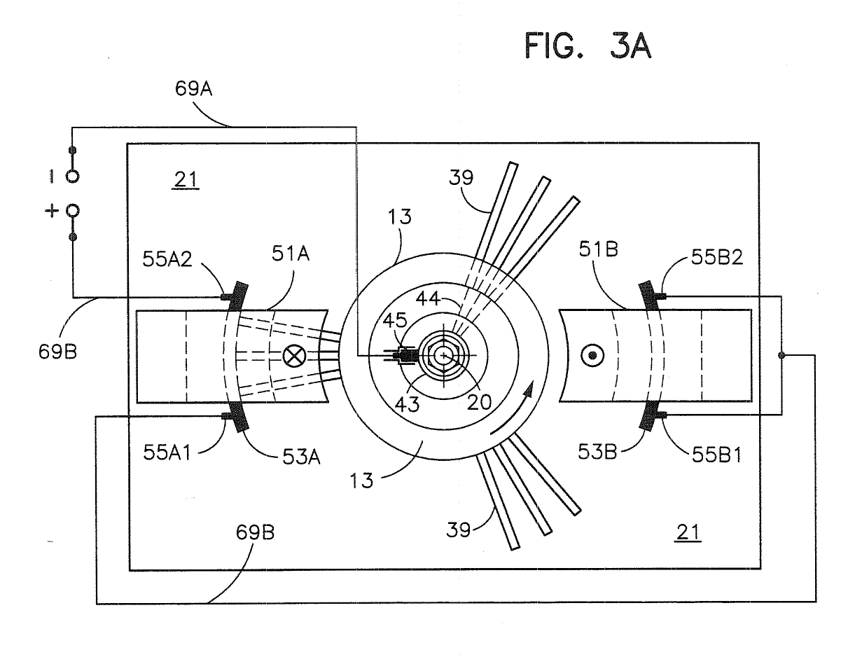

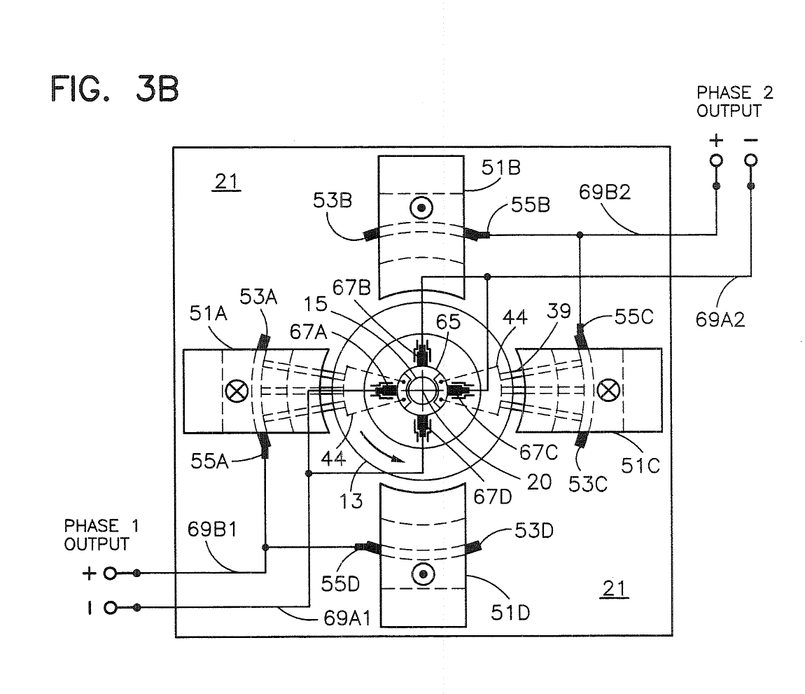

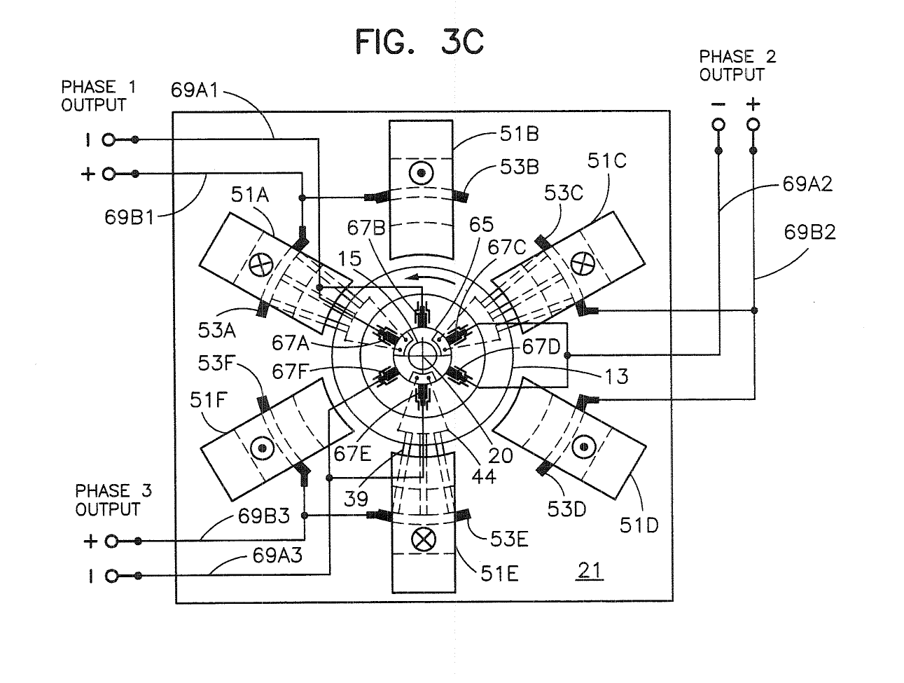

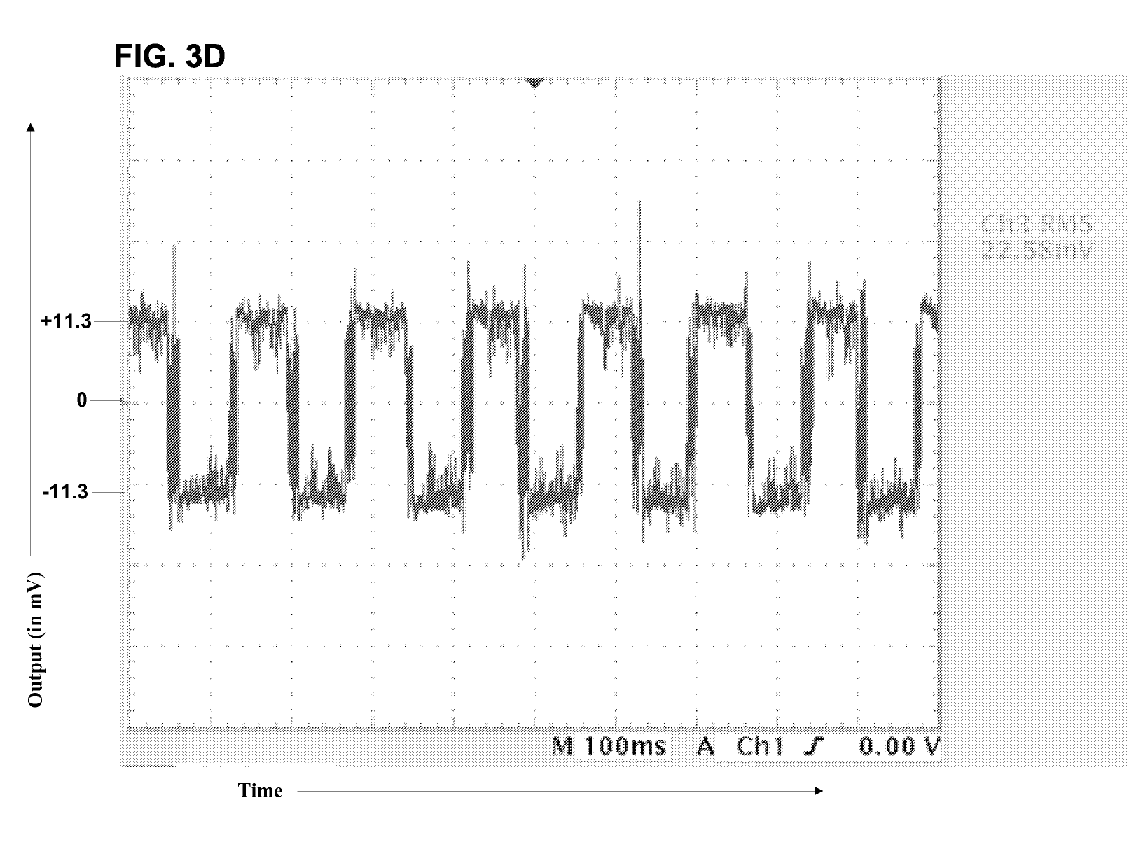

FIG. 3A is a top schematic view of a tenth embodiment of an electrical machine according to the present application. In the tenth embodiment, the carousel 13 supports nine rods 39 (i.e., three groups of rods 39 with the groups spaced every 120° about the rotational axis 20) that lie in a plane perpendicular to the rotational axis 20 of the carousel 13 and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine. It also includes a pair of permanent U-shaped magnet units 51A and 51B that is supported at stationary positions on the top side of the platform 21 opposite one another with the carousel 13 therebetween. The poles of each respective magnet units 51A, 51B are configured to produce a static magnetic field flux whose primary direction is parallel but spaced radially apart from the rotational axis 20. The static magnetic field flux produced by the magnet unit 51A has one polarity (for example, into the page as noted by the label [symbol] ), while the static magnetic field flux produced by the magnet unit 51B has the opposite polarity (for example, out of the page as noted by the label \textcircled{•}). The magnetic fields' fluxes produced by the magnet units 51A, 51B are preferably equal in magnitude. The rods 39 rotate in a plane that passes through the openings between the poles of the magnet units 51A, 51B and that lies perpendicular to the primary directions of the static magnetic field lines of force produced by the magnet units 51A, 51B. The dimensions (e.g., width and length) of the opposed poles of the respective magnet units 51A, 51B are configured such that the static magnetic field's lines of force produced by respective magnet units 51A, 51B interact with the respective groups of adjacent rods 39 (i.e., the three rods for each of the three groups) as the rods 39 rotate about the rotational axis 20. A pair of crescent-shaped conductive brushes 53A, 53B is supported within the interior space of the respective magnet units 51A, 51B. Each brush 53A, 53B is configured to contact and electrically connect to the peripheral ends of the respective groups of adjacent rods 39 (i.e., the three rods for each of the three groups) that interact with the corresponding magnet units 51A, 51B as the rods 39 rotate about the rotational axis 20. One or more output terminal connectors (two shown as 55A1, 55A2) are electrically connected to the brush 53A, and one or more output terminal connectors (two shown as 55B1, 55B2) are electrically connected to the brush 53B. The output terminal connectors for the two brushes 53A, 53B are connected in a serial arrangement and terminate at conductor 69B for the output terminal (+) of the machine. Brush 45 is electrically connected to the slip ring 43 and is connected to conductor 69A for the output terminal (−) of the machine.

The brush 45, the slip ring 43, the conductors 44, the rods 39, and the brushes 53A, 53B form a circuit between the first and second output terminals (“−” and “+”). In the tenth embodiment of FIG. 3A, the spacing of the rods 39 about the circumference of the carousel 13 is staggered such that as the rods 39 rotate about the rotational axis, as a respective group of rods 39 interact with the magnetic field flux produced by the first magnet unit 51A (which has positive polarity—as observable as into the page as noted by the label [symbol] ) while contacting the brush 53A, no other rods interact with the magnetic field produced by the second magnet unit 51B while contacting brush 53B. In this staggered configuration, as the respective groups of rods 39 interact with the so-called positive polarity of the magnetic field's lines of force produced by the first magnet unit 51A while contacting the brush 53A, there is induced (positive polarity) electromotive force (emf) and concomitant positive direction interrupted-mode DC voltage that flows radially outward through the respective group of rods toward the second (“+”) output terminal. Similarly, the respective groups of rods 39 will interact with the opposite (so-called negative) polarity magnetic field's lines of force produced by the second magnet unit 51B (which has negative/opposite polarity—as observable as out of the page as noted by the label \textcircled{•}) while contacting the brush 53B. However, because the magnetic field flux produced by the second magnet unit 51B is of opposite (negative) polarity (flux direction) with respect to the magnetic field produced by the first (positive polarity) magnet unit 51A, the induced (so-called negative polarity) electromotive force (emf) and concomitant negative direction interrupted-mode DC voltage flows radially inward (in the opposite/negative direction as compared to current induced by the magnetic field of the first magnet 51A) through the respective groups of rods toward the first (“−”) output terminal. In this manner, the rotation of the rods 39 (set in three groups) in the plane perpendicular to the both static magnetic fields flax (of one of positive direction and of one of negative direction) produced by the magnet units 51A, 51B respectively, causes a cyclical interception of the such magnetic fields lines of forces and induce alternately electromotive force (emf) of positive and negative polarity (one to another) and concomitant alternating dual-polarity voltage in the rods 39 that flows the circuit between the output terminals (−) and (+) of the electrical machine. The alternating dual-polarity voltage signals output by the embodiment of FIG. 3A generally forms a rectangular waveform of alternating positive and negative polarity. (The output of the machine for a test was coupled to a fixed-value resistive load as is shown and explained on the FIG. 1L and FIG. 3D to record and measure the output by oscilloscope and electrical meters.) The alternating dual-polarity voltage signals combine alternately, its segments of positive direction and its segments of negative direction to form the rectangular waveform of alternating positive and negative polarity as the output of the machine. An example of this alternating dual-polarity voltage signal is described below with respect to FIG. 3D. Note that in the configuration of FIG. 3A, there are three sets of staggered rods 39 with each set having three rods. The three sets of rods are staggered about sectors of the circumference carousel 13 that are offset at approximately 120° from one another as shown.

FIG. 3B is a top schematic view of an eleventh embodiment of an electrical machine according to the present application. It is similar in construction to the tenth embodiment as described above. In the eleventh embodiment, the carousel 13 supports six rods 39 (i.e., two groups of three rods each with the groups distributed at 180° about the rotational axis 20) that lie in a plane perpendicular to the rotational axis 20 of the carousel 13 and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine. It also includes four permanent U-shaped magnet units 51A, 51B, 51C, 51D that are supported in the stationary positions on the top side of the platform 21 with even spacing (i.e., at 90° intervals) about the perimeter circumference of the carousel 13. Particularly, the magnet units 51A and 51C are disposed on opposite sides of the carousel 13 [i.e., at 90° (3 o'clock) and 270° (9 o'clock)], and the magnets 51B and 51D are disposed on opposite sides of the carousel 13 [i.e., at 0° (12 o'clock) and 180° (6 o'clock)]. The magnetic poles of each respective magnet unit 51A, 51B, 51C, 51D are configured to produce static magnetic fields fluxes whose primary direction is parallel but spaced radially apart from the rotational axis 20. The static magnetic fields lines of force produced by the magnet units 51A and 51C have one (positive) polarity (for example, into the page as noted by the label [symbol] ), and that static magnetic fields lines of force produced by the magnet units 51B and 51D have the opposite (negative) polarity direction (for example, out of page as noted by the label\textcircled{•}). The static magnetic fields produced by the magnet units 51A, 51B, 51C, 51D are preferably equal in magnitude. The rods 39 rotate in a plane that passes through the openings between the magnetic poles of the magnet units 51A, 51B, 51C, 51D and that lies perpendicular to the primary directions of the static magnetic fields' fluxes produced by the magnet units 51A, 51B, 51C, 51D. The dimensions (e.g., width and length) of the opposed poles of the respective magnet units 51A, 51B, 51C, 51D are configured such that the static magnetic fields produced by respective magnet units 51A, 51B, 51C, 51D interact with the respective groups of three adjacent rods 39 during certain rotational intervals of the rotational cycle of the rods 39 and carousel 13 about the rotational axis 20. Four crescent-shaped conductive brushes 53A, 53B, 53C, 53D are supported within the interior space of the respective magnet units 51A, 51B, 51C, 51D. Each brush 53A, 53B, 53C, 53D is configured to contact and electrically connect to the peripheral ends of the respective groups of three rods 39 that interact with the corresponding magnet units 51A, 51B, 51C, 51D as the rods 39 rotate about the rotational axis 20. A commutator element 65 replaces the slip ring and is fixed to the top end of the shaft 15 such that it rotates with the shaft 15. The commutator element 65 is constructed according to a logical partitioning of the 360° rotational movement of the carousel 13 that includes two predefined and non-overlapping sectors (connecting sectors) that are disposed opposite one another and provide electrical connection via conductors 44 to two corresponding groups of rods 39 as shown on the FIG. 3B. The commutator element 65 also defined two additional predefined and non-overlapping disconnecting sectors disposed opposite one another and interposed between the two connecting sectors. The disconnecting sectors of the commutator element 65 provide electrical disconnection to the groups of rods as shown in FIG. 3B. During the first two of four rotational intervals corresponding to the connecting sectors, the commutator element 65 provides for electrical connection between brushes 67A, 67C and the conductors 44 for two opposite groups of rods 39, while the two opposite disconnecting sectors for these rotational intervals provide for electrical disconnection between the brushes 67B, 67D and the conductors 44 for the two corresponding groups of rods as shown. In this manner, the connecting sectors electrically connects the group of rods at 9 o'clock to the brush 67A and electrically connect the group or rods at 3 o'clock to the brush 67C, while the disconnecting sectors of the commutator element 65 electrically disconnects the group of rods at 12 o'clock from brush 67B and electrically disconnects that group of rods at 6 o'clock from brush 67D. During the next two of the four rotational intervals (in a 90° counter-clockwise rotation), the connecting sectors electrically connects the group of rods at 12 o'clock to the brush 67B and electrically connects the group or rods at 6 o'clock to the brush 67D, while the disconnecting sectors of the commutator element 65 electrically disconnects the group of rods at 9 o'clock from brush 67A and electrically disconnects the group of rods at 3 o'clock from brush 67C. The commutator element 65 alternately provides for electrical connection and electrical disconnection for two opposite groups of rods 39 with two opposite pairs of brushes 67A-67C and 67B-67D respectively, during the four rotational intervals. One or more output terminal connectors (one shown) are electrically connected to each respective brush 53A, 53B, 53C, 53D, 67A, 67B, 67C, 67D. The electrical machine outputs alternating dual-polarity voltage signals from the output terminals for two phases. For one phase, the output terminals for the commutator brushes 67A, 67D are connected in parallel and terminate a conductor 69A1 for the first output terminal (−) of the phase 1 output of the machine. The output terminal connectors for the two brushes 53A, 53D are connected in parallel and terminate at conductor 69B 1 for the second output terminal (+) for the phase 1 output of the machine. For the other phase, the output terminals for the commutator brushes 67B, 67C are connected in parallel and terminate at conductor 69B 1 for the first output terminal (−) for the phase 2 output of the machine. The output terminals for the brushes 53B, 53C are connected in parallel and terminate at conductor 69B2 for the second output terminal (+) for the phase 2 output of the machine.

In the eleventh embodiment of FIG. 3B, the staggered spacing of the rods 39 about the circumference of the carousel 13 and the staggered configuration of the commutator element 65 (sectors), dictates that electromotive force and concomitant alternating dual-polarity voltage is induced in the two opposite groups of rods as these groups of rods rotate about the axis 20. For example, during one rotational interval defined by the commutator element 65, a first group of three rods 39 interacts with the magnetic field lines of force produced by the magnet unit 51A while contacting the brush 53A, and the second (opposed) group of three rods interacts with the magnetic field lines of force produced by the magnet unit 51C while contacting the brush 53C. During this rotational interval, the commutator element 65 provides electrical connection between the commutator brush 67A and the conductors 44 for the first group of three rotating rods as well as an electrical connection between the commutator brush 67C and the conductors 44 for the second (opposed) group of three rotating rods, while at the same moment the commutator element 65 is itself isolating (disconnecting) the commutator brushes 67B and 67D from electrical connection from rotating rods 39 and crescent-shaped brushes 53B and 53D. In this configuration, as the first group of three rods 39 interacts with the magnetic field lines of force produced by the magnet unit 51A while contacting the brush 53A, there is induced electromotive force and concomitant interrupted-mode DC voltage that flows radially outward through the first group of rods toward the second (“+”) output terminal of the phase 1 output. Similarly, the second (opposite) group of rods 39 interacts with the magnetic field flux produced by the magnet unit 51C while contacting the brush 53C and induces emf and concomitant interrupted-mode DC voltage that flows radially outward through the second group of rods toward the second (“+”) output terminal of the phase 2 output. Continuously during the next successive rotational interval (by 90° revolution) the above explanation is applicable adequately under a condition that both magnetic fields of the magnet units 51B and 51D have opposite polarity direction of their respective fields flux and this consecutive rotational interval of the two opposite groups of rods 39, will implicate to produce opposite directional electromotive force and its concomitant interrupted-mode DC. During the next successive rotational interval the first group of three rods 39, interact with the magnetic field lines of force produced by the magnet unit 51D while contacting the brush 53D, and the second (opposed) group of three rods interact with the magnetic field flux produced by the magnet unit 51B while contacting the brush 53B. However, as it was mentioned above—because the magnetic field flux produced by the magnet units 51D and 51B are of opposite polarity (direction) with respect to the magnetic field flux produced by the magnet units 51A and 51C, the induced electromotive force and concomitant interrupted-mode DC voltage flows radially inward (in the opposite direction as compared to emf and current induced by the magnetic field of the magnet units 51A and 51C) toward the first (“−”) output terminals of the phase 1 output and the phase 2 output, respectively. These two opposite directional electromotive forces with their concomitant interrupted-mode DC voltages, in the first rotational interval and configuration of magnetic fields of the magnet unit 51A and 51C flowing outward direction in both output phases toward output terminals (+) and then change their flow to inward direction in both output phases toward output terminals (−) during the next interval rotation and configuration of magnetic fields of the magnet unit 51D, 51B—thus creating alternating dual-polarity voltage in the rods 39 that flows in both phases circuits between the output terminals (−) and (+).

In this manner, the rotation of the rods 39 in the plane perpendicular to the static magnetic fields flux produced by the magnet units' pairs 51A-51C and 51D-51B, causes a cyclical interception of the such magnetic fields and induces electromotive force and concomitant alternating dual-polarity voltage in the rods 39 that flows between the output terminals (−) and (+) for two phases of the electrical machine. The alternating dual-polarity voltage signals output by the two phases of the embodiment of FIG. 3B generally forms a rectangular waveform of alternating positive and negative polarity (directions). (The output of the machine for a test was coupled to a fixed-value resistive load as is shown and explained on the FIG. 1L and FIG. 3D to record and measure the output by oscilloscope and electrical meters.) An example of this alternating dual-polarity voltage signal in the rectangular waveform is described below with respect to FIG. 3D.

FIG. 3C is a top schematic view of a twelfth embodiment of an electrical machine according to the present application. It is similar in construction and operation to the eleventh embodiment as described above. In the twelfth embodiment, the carousel 13 supports nine rods 39 that lie in a plane perpendicular to the rotational axis 20 of the carousel 13 and extend radially outward away from the rotational axis 20 along directions whose angular coordinates are distributed about the 360° around the origin (rotational axis) as shown. The three groups of adjacent three rods are evenly spaced (i.e. at every 120° angle) around the perimeter circumference of the carousel 13. The space between the rods 39 is occupied by air, which acts as an electrical insulator at the intended operating conditions of the machine. It also includes a six permanent U-shaped magnet units 51A, 51B, 51C, 51D, 51E, 51F that are supported in stationary positions on the top side of the platform 21 with even spacing (i.e., 60° intervals) about the circumference of the carousel 13. The poles of each respective magnet unit 51A, 51B, 51C, 51D, 51E, 51F are configured to produce a static magnetic field whose primary direction is parallel but spaced radially apart from the rotational axis 20. The static magnetic fields produced by the magnet units 51A, 51C, 51E have one polarity (for example, into the page as noted by the label [symbol] ), and that static magnetic fields produced by the magnet units 51B, 51D, 51F have the opposite polarity (for example, out of the page as noted by the label \textcircled{•}). The static magnetic fields produced by the magnet units 51A, 51B, 51C, 51D, 51E, 51F are preferably equal in magnitude. The rods 39 rotate in a plane that passes through the openings between the poles of the magnet units 51A, 51B, 51C, 51D, 51E, 51F and that lies perpendicular to the primary directions of the static magnetic fields' lines of force produced by the magnet units 51A, 51B, 51C, 51D, 51E, 51F. The dimensions (e.g., width and length) of the opposed poles of the respective magnet units 51A, 51B, 51C, 51D, 51E, 51F are configured such that the static magnetic fields produced by respective magnet units 51A, 51B, 51C, 51D, 51E, 51F interact with the respective groups of three adjacent rods 39 during certain intervals (sectors) of the rotational cycle of rods 39 and carousel 13 about the rotational axis 20. Six crescent-shaped (radial) conductive brushes 53A, 53B, 53C, 53D, 53E, 53F are supported within the interior space of the respective magnet units 51A, 51B, 51C, 51D, 51E, 51F. Each brush 53A, 53B, 53C, 53D, 53E, 53F is configured to contact and electrically connect to the peripheral ends of the respective groups of three adjacent rods 39 as the rods 39 rotate about the rotational axis 20. A commutator element 65 replaces the slip ring and is fixed to the top end of the shaft 15 such that it rotates with the shaft 15. The commutator element 65 is constructed according to a logical partitioning of the 360° rotational movement of the carousel 13 that includes three predefined and non-overlapping sectors (connecting sectors) corresponding to the three groups of rods 39 and three disconnecting sectors interposed between the connecting sectors, corresponding to the three empty intervals of the peripheral circumference of the carousel 13. The connecting sectors of the commutator element 65 are electrically connected via conductors 44 to three groups of rods 39. The connecting sectors of the commutator element 65 provide for alternating electrical connection between the commutator (central) brushes 67A, 67B, 67C, 67D, 67E, 67F and the conductors 44 for the three groups of rods 39 during rotation of the carousel 13 (and the three groups of rods 39). The disconnecting sectors of the commutator element 65 are interposed between the connecting sectors and are electrically disconnected to the three groups of rods 39. The disconnecting sectors of the commutator element 65 provide for electrical disconnection (isolation) between the commutator (central) brushes 67A, 67B, 67C, 67D, 67E, 67F and the conductors 44 for the three groups of rods 39 during rotation of the carousel 13 (and the three groups of rods 39). During three of six rotational intervals of the carousel 13, the connecting sectors of the commutator element 65 provide for electrical connection between the brushes 67A, 67C, 67E and the conductors 44 for three groups of rotating rods (i.e., the group at 10 o'clock is electrically connected to brush 67A, the group at 2 o'clock is electrically connected to brush 67C, and the group at 6 o'clock is electrically connected to brush 67E), and the disconnecting sectors of the commutator element 65 provide for electrical disconnection between the brushes 67B, 67D, 67F and the conductors 44 for three groups of rotating rods (i.e., the group at 12 o'clock is electrically disconnected from brush 67B, the group at 4 o'clock is electrically disconnected from brush 67D, and the group at 8 o'clock is electrically disconnected from brush 67F). For the other three rotational intervals, while rods 39 with carousel 13 rotated (moved) by 60° to the next rotational interval, the connecting sectors of the commutator element 65 provide for electrical connection between the brushes 67B, 67D, 67F and the conductors 44 for three groups of rotating rods (i.e., the group at 12 o'clock is electrically connected to brush 67B, the group at 4 o'clock is electrically connected to brush 67D, and the group at 8 o'clock is electrically connected to brush 67F), and the disconnecting sectors of the commutator element 65 provide for electrical disconnection between the brushes 67A, 67C, 67E and the conductors 44 for three groups of rotating rods (i.e., the group at 10 o'clock is electrically disconnected from brush 67A, the group at 2 o'clock is electrically disconnected from brush 67C, and the group at 6 o'clock is electrically disconnected from brush 67E). One or more output terminal connectors (as shown) are electrically connected to each respective brush 53A, 53B, 53C, 53D, 53E, 53F, 67A, 67B, 67C, 67D, 67E, 67F. The electrical machine outputs alternating dual-polarity voltage signals from the output terminals for three phases. The three phases are synchronous to one another and are referred to as first, second and third phases for the sake of description only. For the first phase, the output terminals for the commutator brushes 67A, 67B are connected in parallel and terminate at conductor 69A1 for first output terminal (−) of the phase 1 output of the machine. The output terminal connectors for the two brushes 53A, 53B are connected in parallel and terminate at conductor 69B1 for the second output terminal (+) for the phase 1 output of the machine. For the second phase, the output terminals for the commutator brushes 67C, 67D are connected in parallel and terminate at conductor 69A2 for the first output terminal (−) for the phase 2 output of the machine. The output terminals for the brushes 53C, 53D are connected in parallel and terminate at conductor 69B2 for the second output terminal (+) for the phase 2 output of the machine. For the third phase, the output terminals for the commutator brushes 67E, 67F are connected in parallel and terminate at conductor 69A3 for the first output terminal (−) for the phase 3 output of the machine. The output terminals for the brushes 53E, 53F are connected in parallel and terminate at conductor 69B3 for the second output terminal (+) for the phase 3 output of the machine.

In the twelfth embodiment of FIG. 3C, the staggered spacing of the rods 39 about the peripheral circumference of the carousel 13 and the configuration of the commutator element 65 dictates that electromotive force and concomitant alternating dual-polarity voltage is induced in the rods 39 as the rods rotate about the axis 20. For example, during one rotational interval defined by the commutator element 65, a first group of three rods 39 interact with the magnetic field produced by the magnet unit 51A while contacting the brush 53A, a second group of three rods interact with the magnetic field produced by the magnet unit 51C while contacting the brush 53C, and a third group of three rods interact with the magnetic field produced by the magnet unit 51E while contacting the brush 53E. During this rotational interval, the commutator element 65 provides electrical connection between the commutator brush 67A and the conductors 44 for the first group of three rotating rods as well as electrical connection between the commutator brush 67C and the conductors 44 for the second group of three rotating rods as well as electrical connection between the commutator brush 67E and the conductors 44 for the third group of three rotating rods, while isolating (disconnecting) the commutator brushes 67B, 67D, 67F from the commutator element itself. In this configuration, as the first group of three rods 39 interact with the magnetic field flux produced by the magnet unit 51A while contacting the brush 53A, there is induced emf and concomitant interrupted-mode DC voltage that flows radially outward through the first group of rods toward the second (“+”) output terminal of the phase 1 output. Similarly, the second group of rods 39 intercept with the magnetic field lines of force produced by the magnet unit 51C while contacting the brush 53C to induce emf and concomitant interrupted-mode DC voltage that flows radially outward through the second group of rods toward the second (“+”) output terminal of the phase 2 output. Similarly, the third group of rods 39 interacts with the magnetic field lines of force produced by the magnet unit 51E while contacting the brush 53E to induce emf and concomitant interrupted-mode DC voltage that flows radially outward through the third group of rods toward the second (“+”) output terminal of the phase 3 output. During the next successive rotational interval, the first group of three rods 39 intercept with the magnetic field flux produced by the magnet unit 51F while contacting the brush 53F, and the second group of three rods interact with the magnetic field flux produced by the magnet unit 51B while contacting the brush 53B, and the third group of three rods intercept with the magnetic field flux produced by the magnet unit 51D while contacting the brush 53D. However, because the magnetic field flux produced by the magnet units 51F, 51B and 51D are of opposite polarity (direction) with respect to the magnetic field produced by the magnet units 51A, 51C and 51E, the induced electromotive force and concomitant interrupted-mode DC voltage flows radially inward (in the opposite direction as compared to current induced by the magnetic field flux of the magnet units 51A, 51C, 51E) toward the first (“−”) output terminals of the phase 1, 2 and 3 outputs, respectively.

In this manner, the rotation of the rods 39 in the plane perpendicular to the static magnetic fields produced by the magnet units 51A, 51B, 51C, 51D, 51E, 51F causes a cyclical interception of the such magnetic fields and induces electromotive force and concomitant alternating dual-polarity voltage in the rods 39 that flows between the output terminals (−) and (+) for three phases of the electrical machine. The alternating dual-polarity voltage signals output by the three phases of the embodiment of FIG. 3C generally forms a rectangular waveform of alternating positive and alternating negative polarity. (The output of the machine for a test was coupled to a fixed-value resistive load as is shown and explained on the FIG. 1L and FIG. 3D to record and measure the output by oscilloscope and electrical meters.) The polarities of the segments of the square wave of the three phases are common to one another and synchronized to one another. An example of this alternating dual-polarity voltage signal is described below with respect to FIG. 3D.

FIG. 3D is a signal trace that illustrates an example of the alternating dual-polarity voltage signal produced by the electrical machine embodiments of FIGS. 3A to 3C. The alternating dual-polarity voltage signal output by the machine generally forms a rectangular waveform of alternating positive and alternating negative polarity when the output of the machine is coupled to a fixed-value resistive load (or which output is recordable and measurable by electrical meters). As it is observable on the FIG. 3D the alternating dual-polarity voltage has two segments in voltage signal, flowing one after another alternately in both directions—the positive direction segment and negative direction segment. The alternating dual-polarity voltage combines alternately two directions of interrupted-mode DC signals—the single positive direction signal (segment) and single negative direction signal (segment). These two opposite directions segments of interrupted direct current combined together create one segmental, alternating dual-polarity voltage in the form of rectangular waveform voltage. In this example, the alternating dual-polarity voltage signal output from the “+” and “−” terminals of phase output of the machine is measured on an oscilloscope. The electrical signal of the “+” terminal of the machine is conditioned by an integrating filter as shown in FIG. 1L. The integrating filter minimizes the brush noise. The ratio of the resistance Rf/Ri dictates the gain of the integrating filter. In this configuration, Rf/Ri is one, and thus unity gain is provided. The resistance Rt of 1 kOhm provides a resistive load to the machine. In the example shown, an embodiment similar that of FIG. 3A employs thirty six conductive coppers rods 39 of one-quarter inch in diameter (with three groups of twelve rods spaced at 120° intervals about the peripheral circumference of the carousel 13) that interact with two U-shaped permanent magnet units (each realized from a side-by-side pair of Alnico iron alloy permanent magnets of 130 pound lifting capacity). The two magnet units are disposed opposite one another about the carousel 13 and produce magnetic fields flux of opposite polarities. This configuration produces the rectangular waveform of alternating positive and alternating negative polarity having a peak-to-peak voltage level on the order of 22.58 mV (approx. +11.3 mV for the positive polarity segments and approx. −11.3 mV for the negative polarity segments) with currents on the order of 11 μA in response to hand-cranking of the drive system 23.

Note that the rectangular waveform of dual-polarity voltage signal produced by the electrical machine embodiments of FIGS. 3A to 3C is similar to standard alternating current (AC) but is characterized by rectangular or square waveforms as compared to the sine waveform of standard AC. However, it can be used to mimic or simulate a standard sinusoidal AC voltage signal, if desired. Therefore, during the simulating test the standard AC power Electrical Meter, did recognize produced by the electrical machine “alternating dual-polarity” voltage as standard AC power, which means that the simulating test conducted on Electrical Meter was successful. It is also contemplated that the three phase outputs can be summed together in parallel to form a higher voltage and current single phase output from the machine.

Also noted that the frequency of the rectangular waveform of dual-polarity voltage signals is dictated by the rate of rotation of the carousel 13 (angular velocity of rotation), the size of radius on which the rods 39 are rotating (magnitude of radius of radial placement), in other words—the diameter of the carousel 13 with creating energy elements, as well as the configuration of placed rods (number of groups and intervals in spacing) and the number of magnets' units used (units number and intervals in spacing). The magnitude of produced voltage level and overall energy power directly depends on the above specified conditions, plus type of magnets used whether they are permanent or electro-magnets and their proximity of the magnets' poles placement, together with their sizes and magnitude of applied magnetic fields, as well as the number, length and diameter of the placed energy generating elements (number, sizes of rods). It is also contemplated that with an extreme high frequency of the alternating dual-polarity current, the rectangular-waveform become to be extremely narrow in both polarities, in the positive polarity and in the negative polarity and become to converts itself to a form of pulsating energy in both polarities. Then because this new alternating pulsating energy has alternating dual-polarity waveform, then specifically could receive its new form as alternating pulsating dual-polarity energy (alternating pulsating current) in the one, two or three phase output power, which again can be summed together in parallel to form a higher dual-polarity pulsating current signals as a single phase output from the machine.

In yet other alternative embodiments, the electrical machine of the present application can have multiple stages stacked vertically, on top of one another (or set horizontally one next to another). Each stage can be realized by any one of the configurations described above (or combinations of them). The direct current, the interrupted-mode direct current or the alternating dual-polarity current output of the stages can be adequately summed together for output. In addition, the electrical machine may have one to three phases as shown, but is not limited to three phases only—it may have more than three phases if desired and each the phases produced by the stages can offset in phase by a predefined offset as desired. It is also contemplated that the three phase outputs can be summed together in parallel to form a higher current single phase output from the machine.

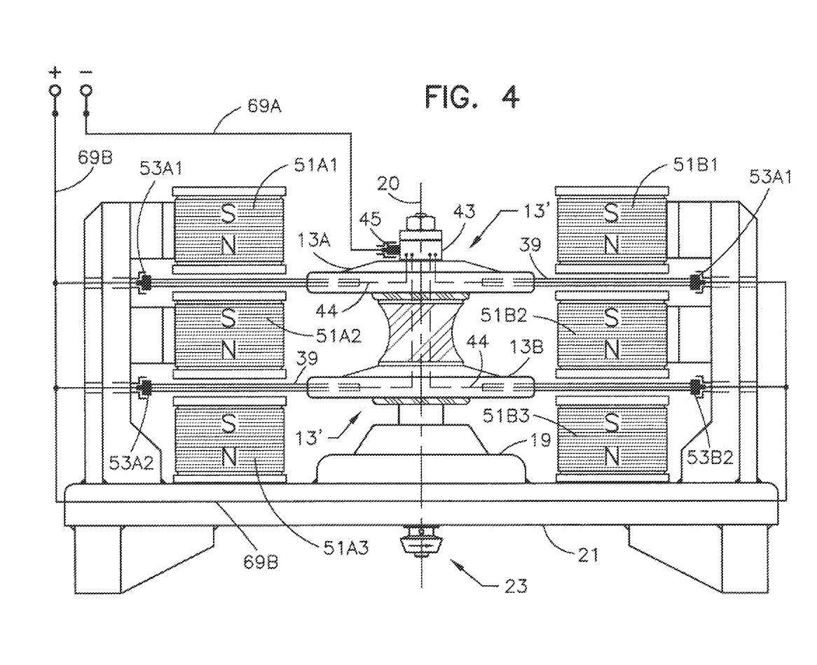

A thirteenth embodiment of an electrical machine with such a multi-stage design is shown in FIG. 4. In this thirteenth embodiment, a spool member 13′ is mated to the rotating shaft 15. The spool member 13′ includes two carousel-like portions 13A, 13B that rotate with the shaft 15 about the rotational axis 20. Similar to the configuration of FIG. 1, the carousel-like portions 13A, 13B each support thirty-six rods 39 that lie in a plane perpendicular to the rotational axis 20 and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine. A slip ring 43 of solid conductive material (such as bronze, brass or copper) is fixably mounted by press-fit about the annular shoulder of the spool member such that it rotates with the spool member and the shaft 15. Similar to the embodiment of FIGS. 1C and 1D, electrical conductors 44 extend between the slip ring 43 and the respective ends of rods 39 that are mated to the carousel-like portions 13A and 13B of the spool member 13′. The electrical conductors 44 can extend through the interior of the spool member. A stationary brush 45 (which is formed of conductive material, such as graphite) slides over the slip ring 43 and remains electrical connected to the slip ring 43 as the slip ring 43 rotates with the spool member and the shaft 15. In this manner, the brush 45 is electrically connected via the conductors 44 to the ends of the conductive rods 39 that are mated to the carousel-like portions 13A and 13B. The machine also includes corresponding pairs of electro-magnets (51A1/51A2 and 51B1/51B2; 51A2/51A3 and 51B2/51B3) that are supported at stationary positions on the top side of the platform 21 opposite one another with the respective carousel-like portions 13A, 13B therebetween. The stationary positions of the electro-magnets 51A1 and 51B1 are disposed vertically above the stationary positions of the corresponding electro-magnets 51A2 and 51B2, and the stationary positions of the electro-magnets 51A2 and 51B2 are disposed vertically above the stationary positions of the corresponding electro-magnets 51A3 and 51B3. The poles of each respective electro-magnet pair (51A1/51A2, 51A2/51A3, 51B1/51B2, and 51B2/51B3) are configured to produce a static magnetic field whose primary direction is parallel but spaced radially apart from the rotational axis 20. The static magnetic fields flux produced by the electro-magnet pairs have the same polarity and are preferably equal in magnitude. The rods 39 that extend from the carousel-like portion 13A rotate in a first plane that passes through gaps between the respective electro-magnet pairs 51A1/51A2 and 51B1/51B2. The rods 39 that extend from the carousel-like portion 13B rotate in a second plane that passes through gaps between the respective electro-magnet pairs 51A2/51A3 and 51B2/51B3. The first rotational plane of the rods that extend from the carousel-like portion 13A is disposed vertically above the second rotational plane of the rods that extend from the carousel-like portion 13B. The dimensions (e.g., width and length) of the opposed poles of the respective electro-magnet pairs are configured such that the static magnetic fields lines of force produced by respective electro-magnet pairs interacts with each set of the rods 39 as the rods 39 and the respective carousel-like portion 13A or 13B rotate about the rotational axis 20. A first pair of crescent-shaped conductive brushes 53A1, 53B1 is configured to mate to the peripheral ends of the rods 39 that extend from the carousel-like portion 13A as the rods 39 rotate in the plane that passes through the gap between the electro-magnet pairs 51A1/51A2 and 51B1/51B2. A second pair of crescent-shaped conductive brushes 53A2, 53B2 is configured to mate to the peripheral ends of the rods 39 that extend from the carousel-like portion 13B as the rods 39 rotate in the plane that passes through the gap between the electro-magnet pairs 51A2/51A3 and 51B2/51B3. The output terminal connectors for the first and second brush pairs 53A1, 53B1, 53A2, 53B2 are connected in parallel and terminate at conductor 69B for the second output terminal (+) of the machine. The output terminal for brush 45 is electrically connected to conductor 69A for first output terminal (−) of the machine.

The brush 45, the slip ring 43, the conductive members 44, the rods 39, and the brushes 53A1, 53A2, 53B1, 53B2 form a circuit between the first and second output terminals (“+” and “−”). The rotation of rods 39 extending from the carousel-like portion 13A in the plane perpendicular to the static magnetic fields flux produced by the electro-magnetic pairs 51A1/51A2 and 51B1/51B2 causes continuous and cumulative interception of the magnetic field lines of force produced by these electro-magnetic pairs and induces emf and concomitant continuous-mode DC voltage in the rods 39 that flows through this circuit. Similarly, the rotation of rods 39 extending from the carousel-like portion 13B in the plane perpendicular to the static magnetic fields flux produced by the electro-magnetic pairs 51A2/51A3 and 51B2/51B3 cause continuous and cumulative interception of the magnetic field lines of force produced by these electro-magnetic pairs and induces emf and concomitant continuous-mode DC voltage in the rods 39 that flows through this circuit. The connection of the brush connectors to the second output terminal (+) functions to sum the induced continuous-mode DC voltage flowing through the respective brushes 53A1, 53B1, 53A2, 53B2. Note that other stacked configurations can be used, with single-phase or any multi-phase or electrically combined phases together in a parallel or serial way. Also, to develop any out-of-phase systems for standard AC motors applications.

The brush(es) of the electrical machine as described herein can be realized from a wear resistant conductive material such as bronze, brass, carbon/graphite powder or mixtures thereof, includes copper materials and its alloys. The brush(es) of the electrical machine as described herein may have a rolling construction, ball construction, baleen-like construction, any combination or other suitable designs to provide reduced friction reliable connectivity and easy operation.

In other embodiment, the magnet(s) of the apparatus can rotate with the one shaft or with the multi shafts of the machine and the conducting rods can be supported in a stationary position on the platform of the machine. In this configuration, the brushes that interface to the rods can be substituted by fixed conductors, and brushes can be used only to provide electrical signals to the magnets (if electro-magnets are used) as desired. The electro-magnets then are set rotatable over stationary rods and could be easily radially expanded outward in circular rows, while each perimeter row has to circularly cover entire stationary set of rods.

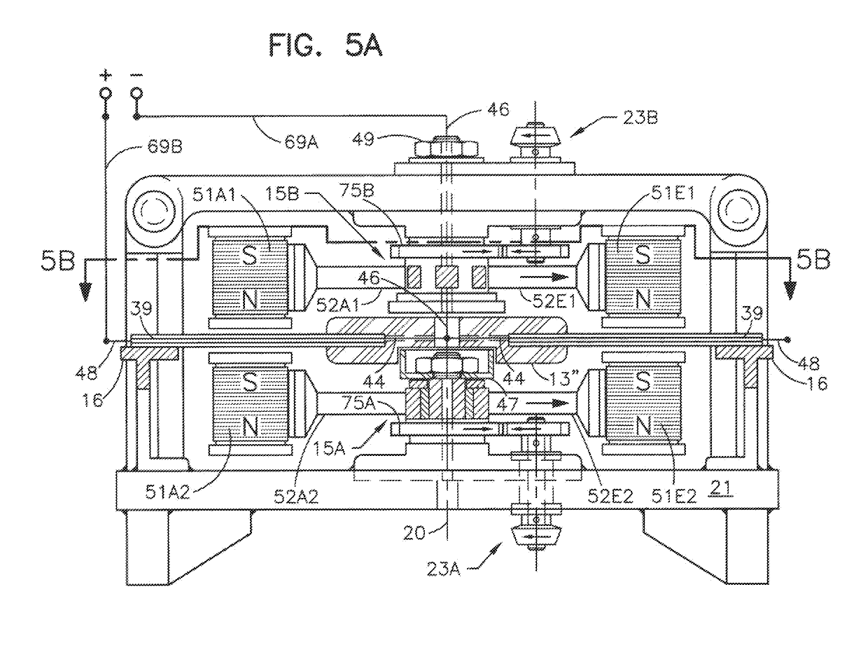

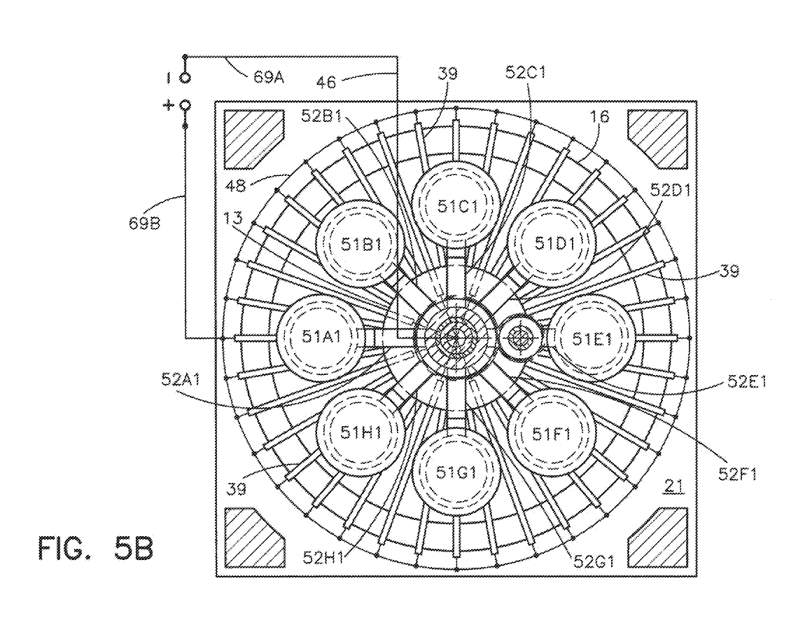

FIGS. 5A and 5B illustrate a fourteenth embodiment of an electrical machine where the electro-magnets of the electrical machine rotate about a rotational axis of the electrical machine and the conducting rods are supported in a stationary position on the platform of the electrical machine. FIG. 5A is a cross-sectional schematic view of the fourteenth embodiment. FIG. 5B is a sectional 5B-5B top schematic view of the fourteenth embodiment of FIG. 5A. In the fourteenth embodiment, a stationary body 13″ supports thirty-six rods 39 that lie in a plane perpendicular to the rotational axis 20 of the machine and extend radially outward away from the rotational axis 20 along directions whose angular coordinates are distributed about the 360° around the origin (rotational axis) as shown. The space between the rods 39 is occupied by air, which acts as an electrical insulator at the intended operating conditions of the machine. The stationary body 13″ is preferably realized from a non-conductive material and thus provides for additional electrical isolation between the rods 39 while acting to mechanically support the rods 39 in place. The stationary body 13″ includes a central bore which extends from the bottom and through the top of the electrical machine as shown. Coaxial rotating hubs 15A, 15B are supported on opposite sides of the stationary body 13″ such that they both rotate about the rotational axis 20. The rotatable hubs 15A, 15B can be mounted on corresponding stationary axles, where one stationary axle is stationary assembled on the bottom plate 21 and the other stationary axel is stationary assembled to the top frame of the electrical machine as best shown in FIG. 5A. The central axes of the stationary axles are aligned to the rotational axis 20 of the electrical machine. The rotatable hub assemblies 15A and 15B can be provided with flanged slide bearings as shown, to secure free rotation about each stationary axles and the rotational axis 20 of the electrical machine. The rotational movement of the hubs 15A, 15B are driven by corresponding gear trains 75A, 75B that are driven by corresponding drive systems 23A, 23B. The drive systems 23A, 23B are operated synchronously such that the hubs 15A, 15B rotate together in synchronous manner. The body 13″ is stationary and does not rotate with the hubs 15A, 15B. The peripheral ends of the rods 39 are supported stationary in a fixed position by a dielectric support 16. The machine also includes eight pairs of electro-magnets units 51A1/51A2, 51B1/51B2, 51C1/51C2, 51D1/51D2, 51E1/51E2, 51F1/51F2, 51G1/51G2, 51H1/51H2 that are supported by corresponding rotating arm pairs 52A1/52A2, 52B1/52B2, 52C1/52C2, 52D1/52D2, 52E1/52E2, 52F1/52F2, 52G1/52G2, 52H1/52H2. Each respective rotating arm pair extends radially away from the rotational axis 20 on opposite sides of the fixed plane of the rods 39 to support the corresponding electro-magnet pair opposite one another on opposite sides of the fixed plane of the rods 39 as best shown in FIG. 5A. The rotating arm pairs are mechanically coupled to the corresponding hubs assembly 15A, 15B such that the arm pairs and the corresponding electro-magnet pairs rotate synchronously with the hubs 15A, 15B. In this configuration, the electro-magnets units 51A1, 51B1 51C1, 51D1, 51E1, 51F1, 51G1, 51H1 and the corresponding rotating arms 52A1, 52B1, 52C1, 52D1, 52E1, 52F1, 52G1, and 52H1 rotate in a first plane, while the electro-magnets units 51A2, 51B2, 51C2, 51D2, 51E2, 51F2, 51G2, 51H2 that are supported by corresponding rotating arm pairs 52A2, 52B2, 52C2, 52D2, 52E2, 52F2, 52G2, 52H2 rotate in a second plane that is offset vertically from the first plane with the stationary rods 39 disposed between the corresponding electro-magnet unit pairs. The arm pairs and the corresponding electro-magnet pairs are distributed evenly at 45° intervals about the rotational axis 20 as best shown in FIG. 5B. The magnetic poles of each respective electro-magnet unit pair are configured to produce a static electro-magnetic field flux whose primary direction is parallel but spaced radially apart from the rotational axis 20. The static electro-magnetic fields produced by the respective electro-magnet unit pairs have the same polarity and are preferably equal in magnitude. The rods 39 are fixed in position in the gap between the rotating electro-magnet unit pairs. The fixed plane of the rods 39 lies perpendicular to the primary directions of the static electro-magnetic field lines of force produced by the rotating electro-magnet unit pairs.

As best shown in FIG. 5A, a first set of central electrical conductors 44 is electrically connected to the respective ends of rods 39 that are mated to the stationary body 13″. The central conductors 44 of the first set are joined together in parallel by a central conductor 46 that extends through a central bore of body 13″ and through a central bore along the rotational axis 20. The central conductor 46 terminates at conductor 69A for the first output terminal (−) of the machine. The first set of central electrical conductors 44 can also extend through the interior of the body 13″ as shown. A second set of radial conductors 48 is electrically connected to the respective radial peripheral ends of rods 39 that are supported by the dielectric support 16. The radial conductors 48 of the second set are joined together in parallel and terminate at conductor 69B for the second output terminal (+) of the electrical machine. A central cup-shaped washer 47 (which is preferably formed of a non-conductive or dielectric material) and central end nuts 49 hold the rotating arms, the gears 75A/75B, and the body 13″ in place about the hubs 15A, 15B during operation.

The conductors 46 and 44, the rods 39, and the conductors 48 form a circuit between the first and second output terminals (“−” and “+”) of the machine. The rotation (radial movement) of electro-magnet unit pairs relative to the stationary rods 39 about the rotational planes perpendicular to the static electro-magnetic field lines of force produced by the electro-magnet unit pairs causes continuous and cumulative interception of the electro-magnetic field lines of force produced by the electro-magnet unit pairs and induces electromotive force (emf) and concomitant continuous-mode DC voltage in the rods 39 that flows through this circuit. The emf and concomitant continuous-mode DC voltage is induced by the Lorentz law of force as described above.

The fourteenth embodiment of FIGS. 5A and 5B avoids the need for conductive brushes, a slip ring and/or a commutator. This can be advantageous as it avoids the friction and losses associated with brush designs and the commutator that can reduce the efficiency of the machine. Similar adaptations can be made to each of the disclosed embodiments to utilize fixed conductive rods or other elongate conductive members and rotating magnetic fields as the permanent magnets or electro-magnets.

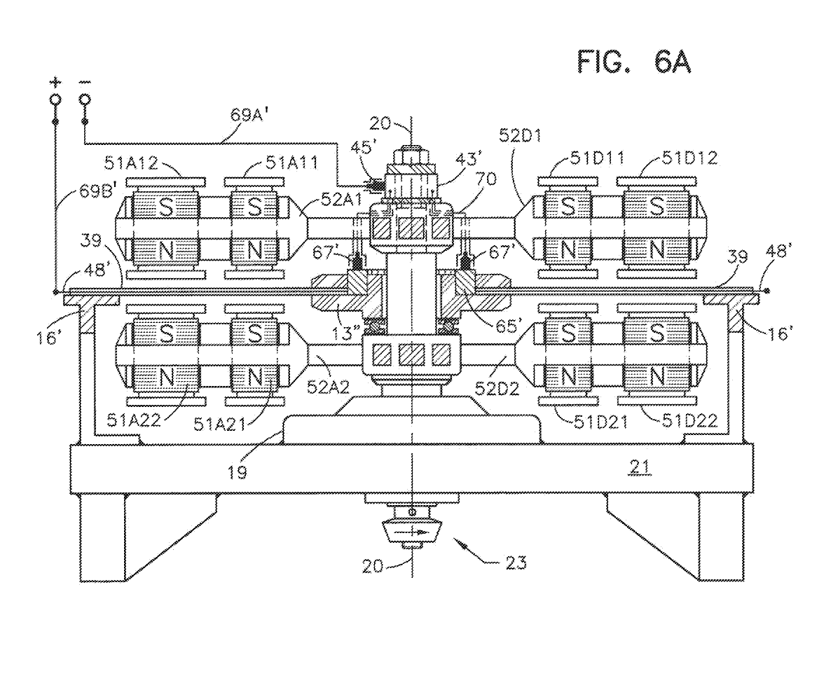

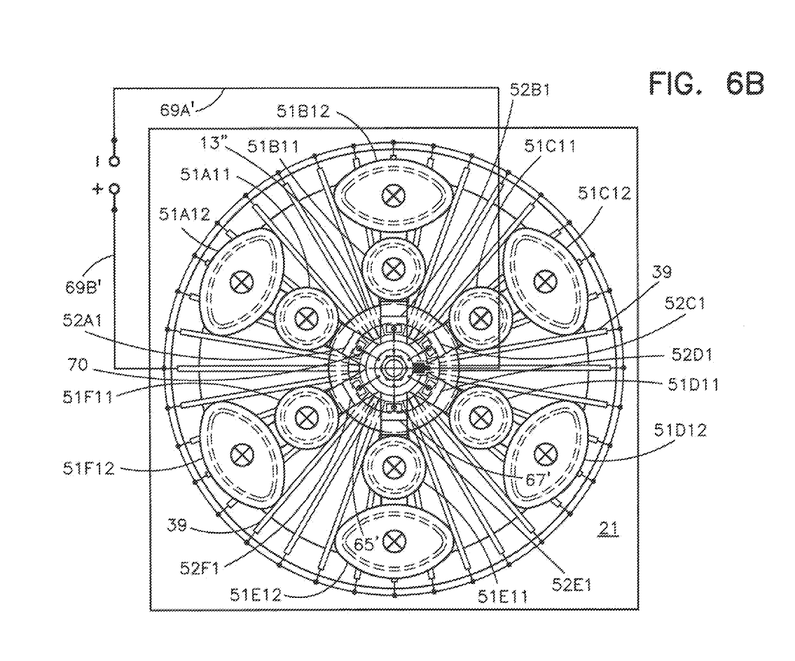

FIGS. 6A and 6B illustrate a fifteenth embodiment of an electrical machine similar in construction to the fourteenth embodiment of FIGS. 5A and 5B.

FIG. 6A is a cross-sectional schematic view of the fifteenth embodiment. FIG. 6B is a top schematic view of the fifteenth embodiment. There are some differences in construction between the embodiment of FIGS. 6A and 6B and the embodiment of FIGS. 5A and 5B. One lies in the construction of a rotatable central shaft 15 with electro-magnets mounted on six rotating arm pairs that together define a rotatable structure that rotates with the shaft 15 with no extra gear train. One rotatable arm (i.e., the “top rotatable arm”) of the pair is disposed above and spaced from the other rotatable arm (i.e., the “bottom rotatable arm”) of the pair similar to the embodiment of FIGS. 5A and 5B. The six top rotating arms are labeled as 52A1, 52B1, 52C1, 52D1, 52E1, 52F1 in FIG. 6B. The shaft 15 is rotatable driven by a central drive system 23 similar to the embodiment of FIG. 1C. Furthermore, a stationary body 13″ is equipped with a stationary central ring type commutator 65′, with both the body 13″ and the commutator 65′ supported as stationary structures on the rotating shaft 15. The stationary central ring commutator 65′ is electrically connected to all of the stationary rods 39 that extend from the body 13″. The stationary central ring commutator 65′ interfaces to each one of six commutator brushes 67′ that extend from the undersides of top rotating arms. Conductors 70 (which can extend through the respective rotating arms) provide for parallel electrical connection between the six brushes 67′ and a slip ring 43′ mounted on the top portion of the rotating shaft 15 (above the arms). A central brush 45′ interfaces to the slip ring 43′. A conductor 69A is electrically connected to the central brush 45′ for the output terminal (“−”) of the electrical machine. The stationary central ring type commutator 65′ together with the brushes 67′, conductors 70, slip ring 43′ and central brush 45′ provides for electrical connection between the output terminal (“−”) of the electrical machine and those rods 39 that are interacting with electromagnetic field flux produced by the rotating pairs of electro-magnets as the arms and corresponding pairs of electro-magnets rotate with the shaft 15 about the rotational axis 20 of the electrical machine. A set of radial conductors 48′ is electrically connected to the respective radial peripheral ends of rods 39 that are supported by the dielectric support 16′. The radial conductors 48′ are joined together in parallel and terminate at conductor 69B′ for the second output terminal (+) of the electrical machine.

As best shown in FIG. 6B, the rotating pairs of electro-magnets for each one of the six arms do not entirely cover all of the rods 39 as the electro-magnets rotate about the rotational axis 20 of the electrical machine. In this example, there are three rods between adjacent radial sets of electro-magnets (for example, the three rods between the radial set of electro-magnets 51A11/51A12 and the radial set of electromagnets 51B11/51B12) that are not covered by the rotating pairs as seen on the FIG. 6B. The ring-type commutator 65′ is configured to disconnect this subset of uncovered rods from the output terminal (“−”) of the electrical machine in order to minimize leakage current through these uncovered rods during rotation of the electro-magnets about the rotational axis 20 of the machine.

In the fifteenth embodiment of FIGS. 6A and 6B, each one of six rotating arm pairs supports two pairs of electro-magnet units. For example, one rotating arm pair supports electro-magnet unit pair 51A11/51A21 and electro-magnet unit pair 51A12/51A22. The electro-magnet units 51A11 and 51A12 are disposed above the plane of the rods 39 and thus shown in the top view of FIG. 6B. Similarly, the electro-magnet units 51A21 and 51A22 are disposed below the plane of the rods 39 as shown in the view of FIG. 6A. Note that electro-magnet units 51A12, 51A22 are offset radially beyond the corresponding electro-magnet units 51A11, 51A21, and the size and corresponding cross-sectional area covered by the outer electro-magnet units 51A12, 51A22 are substantially larger than the size and cross-sectional area covered by the inner electro-magnet units 51A11, 51A21. This type construction dictates that the electro-magnetic field lines of force (flux) produced by the electro-magnet unit pairs supported by each respective rotating arm increases in coverage area as a function of radial offset from the rotational axis 20, which mirrors that widening area covered by the rods 39 as the rods extend radially away from the rotational axis 20. This configuration can be useful for strengthening the electro-magnetic field for large generators or motors.

It is also contemplated that fifteenth embodiment of FIGS. 6A and 6B can replace the ring-type commutator 65′ with a continuous ring electrode together with rectifier semiconductor diodes electrically connected between the central end of each rod and the continuous ring electrode. The rectifier semiconductor diodes allow electric current to pass in one direction (called the diode's forward direction and is configured to allow current to pass through the rods toward the central ring electrode and the “+” output terminal of the machine), while blocking current in the opposite direction (the reverse direction).

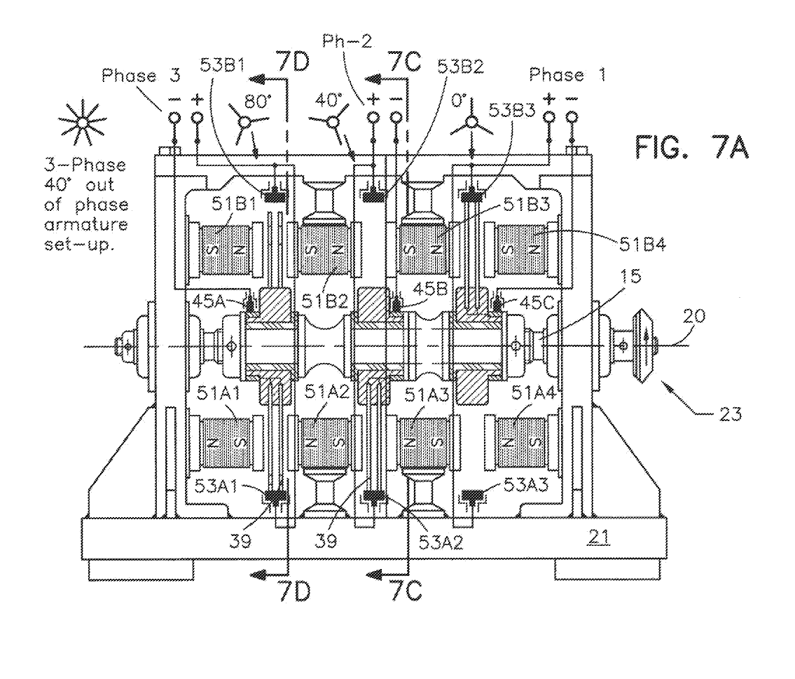

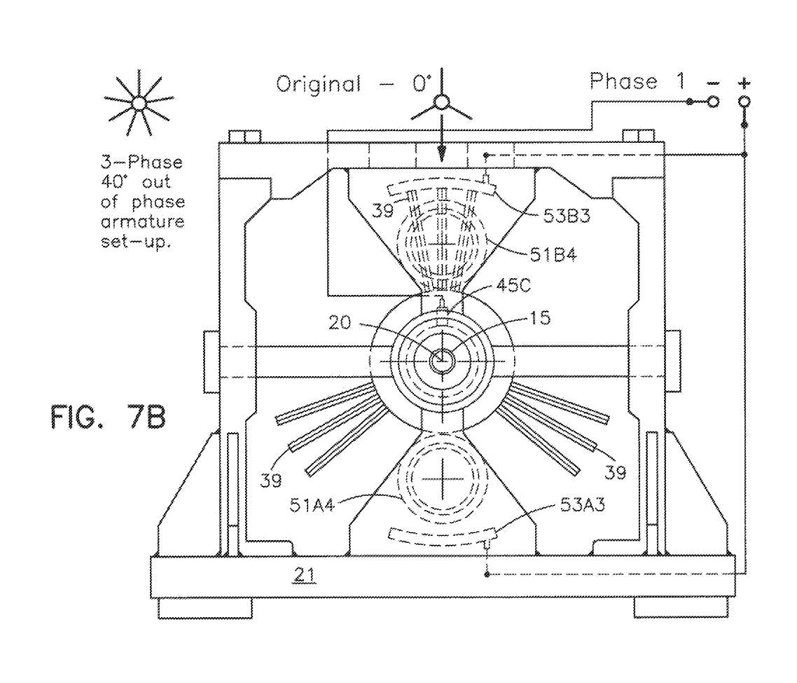

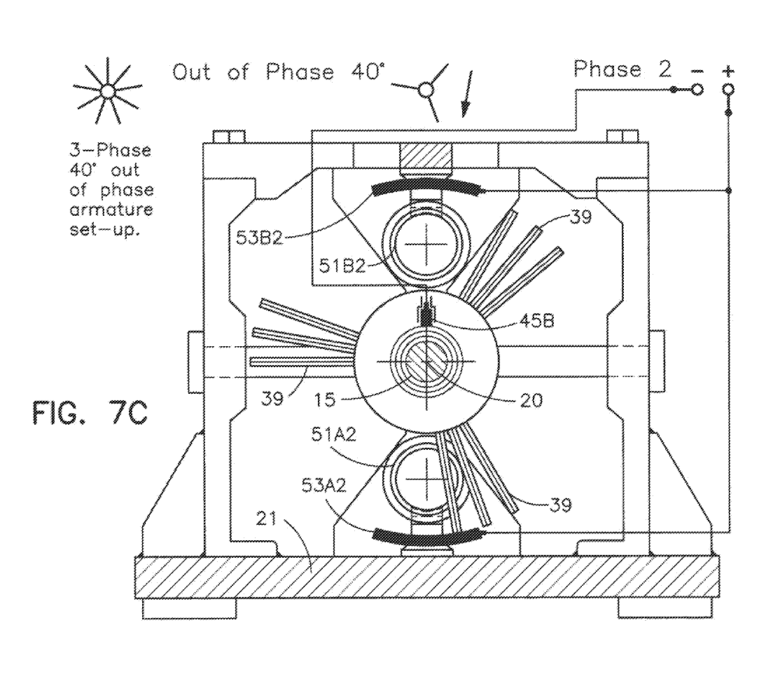

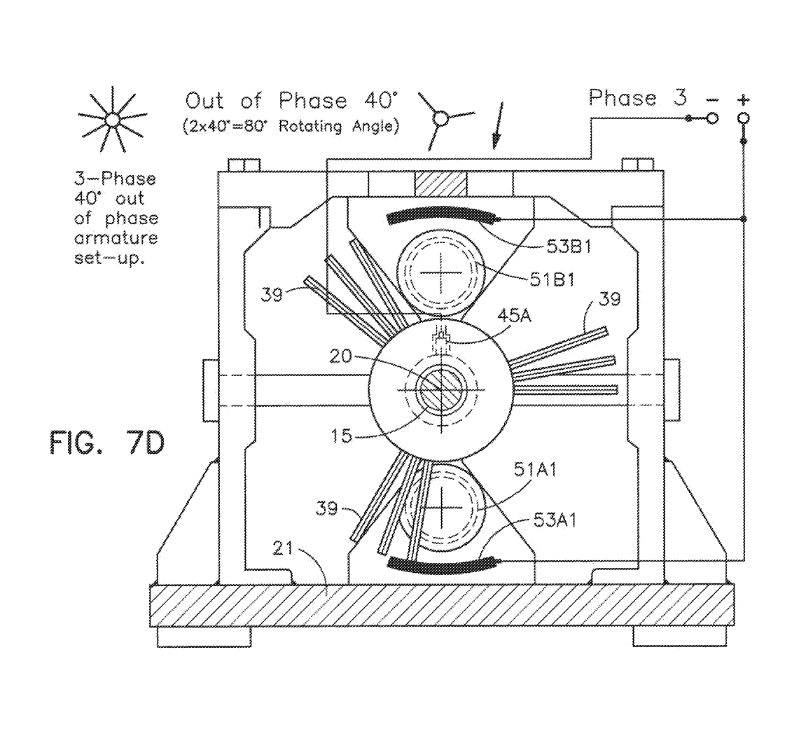

FIGS. 7A, 7B, 7C and 7D illustrate a sixteenth embodiment of an electrical machine similar to the stacked arrangement of FIG. 4, with a major difference that FIG. 4 represents multiple stages stacked vertically producing a single phase continuous-DC output and the stacked arrangement of FIG. 7 represents three stages stacked horizontally where the stages produce alternating dual-polarity voltage outputs whose phases are offset from one another. Specifically, the middle stage is offset 40 degrees in phase relative to the right and left stages. Thus, the right and left stages are offset 80 degrees in phase. FIG. 7A is a cross-section schematic view of the sixteenth embodiment. FIG. 7B is a right side schematic view of the sixteenth embodiment illustrating the operation of the right stage of the machine. FIGS. 7C and 7D are sectional schematic views of the sixteenth embodiment illustrating the operation of the middle and left stages of the machine. Each one of the three stages (horizontal sectors) employs a configuration similar to the tenth embodiment described above with respect to FIG. 3A to generate a single phase alternating dual-polarity output signal with stacked rod pairs similar to the second embodiment of FIGS. 1E and 1F. Each stage is rotated by 40° one in comparison to the position of the other, to exactly establish three-phases with 40° out of each phase system of the electrical machine. In this alternate embodiment, the rotational axis 20 of the electrical machine is oriented in a direction parallel to the base plate support 21. In this configuration, the rotational axis 20 is typically orientated horizontally (perpendicular to the direction of gravity).

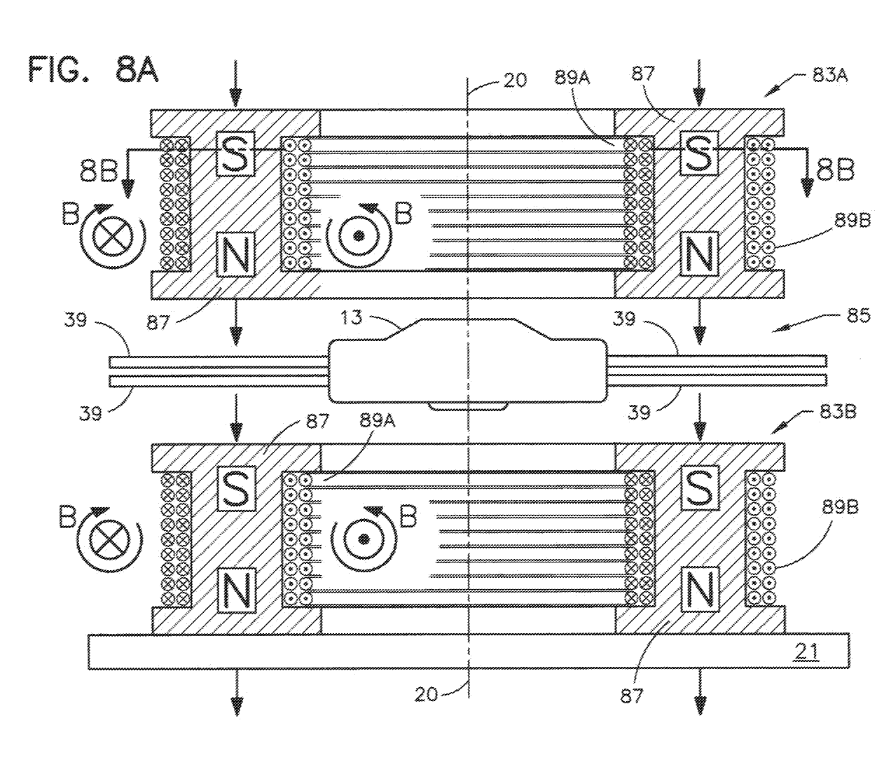

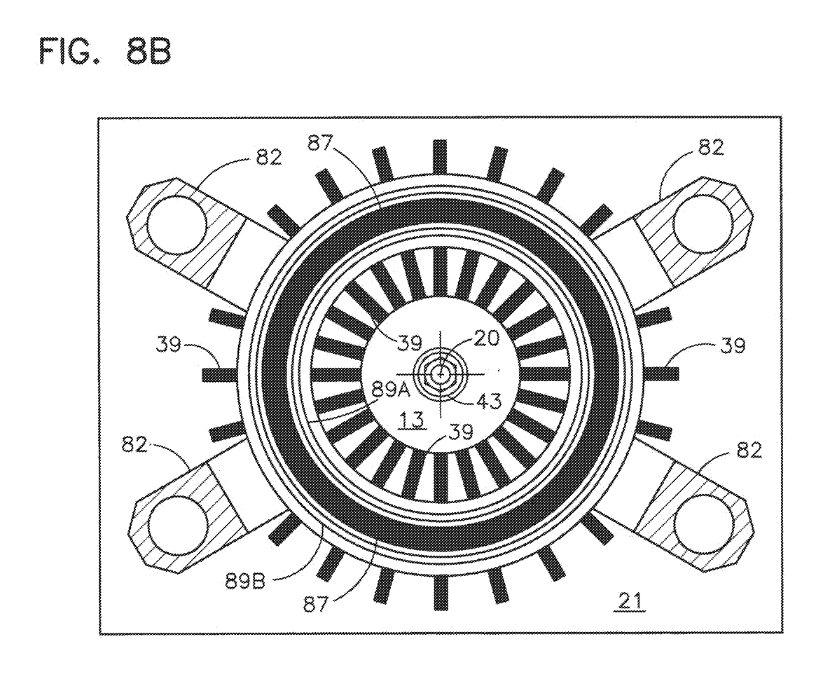

FIG. 8A is a cross-section view of another alternate embodiment of an electrical machine according to the present application. FIG. 8B is a sectional 8B-8B top schematic view of the electrical machine of the embodiment of FIG. 8A. The alternate embodiment of electrical machine shown on FIGS. 8A and 8B are similar in construction to the fifth embodiment of FIGS. 1I and 1J. In this embodiment, the carousel 13 supports two sets of thirty-six rods 39 (stacked in pairs one on top of the other) that lie in a plane perpendicular to the rotational axis 20 of the carousel 13 and extend radially outward away from the rotational axis 20 along directions whose angular coordinates are distributed about the 360° around the origin (rotational axis) similar to the second embodiment of FIGS. 1E and 1F as shown. The space between the rods 39 is occupied by air, which acts as an electrical insulator at the intended operating conditions of the machine. A pair of cylinder-shaped electro-magnets 83A, 83B (or segmented cylinder pairs) is supported at stationary positions on the top side of the platform 21 with a gap 85 therebetween. The stacked rod pairs 39 rotate in a plane that passes through the gap 85. The cylinder-shaped electro-magnet 83A is supported by mounts 82 in a fixed position above the plane of the stacked rods 39. The cylinder-shaped electro-magnet 83B is supported by the top surface of the platform 21 in a fixed position opposite the cylinder-shaped electro-magnet 83A below the plane of the rods 39. Each respective cylinder-shaped electro-magnet has an annular core 87 that supports an inner winding 89A disposed along the inner annular sidewall of the core 87 and an outer winding 89B disposed along the outer annular sidewall of the core. Each loop of both the inner and outer windings 89A, 89B extend in a (radial) plane substantially perpendicular to the rotational axis 20. In this configuration, both the inner winding 89A and outer winding 89B extend along a respective annular sidewall of the core 87 in a direction parallel to the rotational axis 20 as best shown in FIG. 8A. The loops of the winding 89A are configured to carry DC current in a (radial) counterclockwise sense, and the loops of the winding 89B are configured to carry DC current in a (radial) clockwise sense. These currents directions produce the poles of a static magnetic field whose primary flux direction (noted by arrows in FIG. 8A) is parallel but spaced apart from the rotational axis 20 about the full peripheral circumference of the carousel 13. The rotational plane of the rods 39 lies perpendicular to the primary direction of the static magnetic field lines of force produced by the cylinder-shaped electro-magnets pair 83A, 83B as shown. The annular configuration of the opposed poles of the respective electro-magnets 83A and 83B produces a static magnetic field flux that interacts with all of the rods 39 as the stacked rods 39 rotate about the rotational axis 20. Similar to the first and second embodiment as described above, the central portion of the carousel 13 supports a slip ring 43 that rotates with the carousel 13. Electrical conductors (not shown) extend between the slip ring 43 and the respective ends of rods 39 that are mated to the carousel 13. A stationary conductive brush (not shown) slides over the slip ring 43 and remains electrically connected to the slip ring 43 as the slip ring 43 rotates with the carousel 13. In this manner, the slip ring brush is electrically connected via the conductors to the ends of the conductive rods 39 that are mated to the carousel 13. A conductor (not shown) is electrically connected to the slip-ring brush to provide a first output terminal (labeled “−”) of the electrical machine. One or more conductive brushes (not shown) are configured to contact and electrically connect to the peripheral ends of the rods 39 as the rods 39 rotate about the rotational axis 20. An output terminal connector (not shown) is electrically connected to the rod brush(es), and is configured to form the second output terminal (+) of the machine. The slip ring brush (not shown), the slip ring 43, the conductors (not shown), the rods 39, and the rod brush(es) (not shown) form a circuit between the first and second output terminals (“−” and “+”). The rotation (radial movement) of rods 39 in the plane perpendicular to the static magnetic field flux produced by the cylinder-shaped electro-magnets 83A, 83B causes continuous and cumulative interception of the magnetic field lines of force produced by the cylinder-shaped magnets 83A, 83B and induces emf and concomitant continuous-mode DC power in the rods 39 that flows through this circuit.

It is contemplated that the windings 89A, 89B of the respective cylinder-shaped electro-magnets 83A, 83B can have multiple vertical layers of winding loops. The cross-sectional view of FIG. 8A shows two vertical layers of winding loops. More than two vertical layers of winding loops can also be used. Nested row configurations of the winding loops can also be used.

It is also contemplated that the opposed cylinder-shaped electro-magnets 83A, 83B can be realized by multiple electro-magnet units. For example, one cylinder-shaped electro-magnet can be placed inside another cylinder-shaped electro-magnet similar to the way you can have one circle or ring inside another. This configuration can be useful for strengthening the magnetic field flux for large generators or motors.

In alternate embodiments, the electrical machines as described above can be used as an electrical motor (or a dual function electrical generator/motor). For the embodiments of FIGS. 1A to 1J and FIG. 4 and FIG. 5A-5B, a continuous DC voltage signal is supplied across the (+) and (−) terminal of the machine to produce mechanical rotation energy of the carousel body 13 and the shaft 15 secured thereto. For the embodiments of FIGS. 2A to 2C, an interrupted-mode DC voltage signal is supplied across the (+) and (−) terminal of the machine to produce mechanical rotation power of the carousel body 13 and the shaft 15 secured thereto. For the embodiments of FIGS. 3A to 3C, and FIG. 7 an alternating dual-polarity voltage signal or rectangular (square) wave voltage signal is supplied across the (+) and (−) terminal of the machine to produce mechanical rotation power of the carousel 13 and the shaft 15 secured thereto. The power of mechanical energy of the rotating shaft 15 can be output from the machine for use in the intended applications as desired.

In alternate embodiments, the permanent magnet(s) of the electrical machine as described above can be substitute by a corresponding electro-magnet(s) as is well known in the art.

The electrical machine can be used in conjunction with a wide variety of electrical loads and electrical sources. For example, as a generator, the electrical machine can be used in conjunction with a wide variety of electrical loads, including fixed resistive loads and loads with complex and/or dynamic impedance. In another example, as a motor, the electrical machine can also be used in conjunction with a wide variety of electrical sources, including sources with a fixed output impedance and sources with complex and/or dynamic output impedance.

In yet other embodiments, many changes may be made to the designs described herein without deviating from the spirit of this invention. Examples of such contemplated variations include the following.

The system of this invention may be adapted for any other related uses.

The shape and size (could be scaled up and scaled down), colors etcetera of the device or the packaging thereof may be modified.

Additional complimentary and complementary functions and features may be added. (The existing features may be combined or separated in other way to create another function or structure.)

The system may be made portable or could be miniaturized.

The invention may be scaled up and down by several order so magnitude.

An experimental science toy version or educational version may be developed for education and entertainment of little young scientists of the future.

A DC servo motor version may be crafted based on this carousel and co-rotational magnet arrangement.

Permanent magnets may be replaced by equivalent configuration of electro-magnets. Electro-magnets can be used to provide a larger magnitude electromagnet field in order to increase overall power of the machine.

A portion of the electricity generated by the apparatus may be fed back to the electro-magnets to explore the possibility of a self-excited generator without violating any laws of nature or thermodynamics.

A water, wind, steam, gas turbine or combustion engine may be used to drive the rotating shaft of the machine to directly produce the output power (continuous-DC mode or interrupted-mode DC or alternating dual-polarity voltage) for the various embodiments described herein.

New constructions may be designed to explore further possibilities of the described and suggested hereto-new structures of the invention but not shown as drawings and figures in this application.

For example, other rotating elongate conductive structures can extend radially perpendicular to the rotational axis of the machine. Such structures can have different cross-sectional shapes, such as rectangular or square, oval or double oval, “T” or double “T” or “E” or “I” shaped. Such structures can also be hollow in form, such as a conductive pipe. This reduces the weight of the conductive structure and does not impact the current capacity of the structure. Also to fit in straightening elongated element to provide more stable, solid but much longer generating energy elements. Such rotating elongate conductive structures can also be formed in a dielectric substrate, such as flat dielectric carousel. Such rotating elongate conductive structures can also be covered with a dielectric coating and integrated onto a rotating body or parts thereof. It is also contemplated that for a large in scale generators and motors, the hollow out in center conductive structure/member as the conductive pipes can be practical in use, due to easy to apply/construct cooling down system from inside of such conductive pipe member, with utilization of a pressurized air.

The carousel could be made from any material possible, including but not limited to, metal or non-metal, nylon, plastics, wood, composites includes fiber-glass, carbon-graphite composites or printed boards to form a solid or light structure to create fastening structure for assembling inside conductors or rods as the device's winding.

It is expected but not limited to, that the ratio of the length and width dimensions of the elongate conductive structures (conductive rods) that interact with the magnetic field of the electrical machine will preferably be 15:1 or more for many applications and such ratio could be limited only (or practically defined) by strength of the materials used to construct (build) them.

It is also contemplated that the machine can be configured as a self-starting generator that employs both permanent magnet(s) and electro-magnet(s). The permanent magnet(s) is(are) used to start the generator, and the voltage signal output from the generator can be used to generate electrical signals that power the electro-magnet(s) of the system. This is especially applicable as electrical machines for vehicles.

The embodiments of the electrical machine that generate (and/or consume) continuous DC current can be used for a wide range of applications, including but not limited to the following:
i) in an electric locomotive where the electrical machine can provide a DC Generator and/or DC Motor of the electric locomotive (or combination of both as the DC Generator/DC Motor system);
ii) in an electric vehicle where the electrical machine can provide a DC Generator and/or DC Motor of the electric vehicle; (in a city passengers transportation systems, as a trolley-bus and a tram-car or a street car where the electrical machine can provide a DC Generator and/or DC Motor of the electric vehicle;
iii) in an electro-plating process where the electrical machine supplies DC current to the electroplating process;
iv) in other DC current processes (such as the conversion of alumina to aluminum) where the electrical machine supplies DC current to the process and in the ship-yards industry for heavy duty welding systems;
v) in heavy duty metal working equipment, presses, compressors, CNC machining, power tools and others, where the electrical machine can provide a DC Generator and/or DC Motor of the equipment;
vi) in heating systems for industrial and households use where the electrical machine can provide a DC Generator and/or DC Motor of the heating system; and
vii) in battery charging systems, where the electrical machine can provide a DC Generator of the battery charging system; and
viii) in cranes and hoists and other load lifting equipment where the electrical machine can provide a DC Generator and/or DC Motor of the equipment.

The embodiments of the electrical machine that generate (and/or consume) interrupted-mode voltage or alternating dual-polarity voltage (or similar as standard AC voltage derived therefrom) can be used for the wide range of applications, including but not limited to:
i) in lightweight or specialty CNC machines, the electrical machine can provide an interrupted-mode DC Generator or alternating dual-polarity voltage generator and/or an interrupted-mode DC Motor or alternating dual-polarity voltage motor of the CNC machine; and
ii) in special equipment (such as the equipment science and research programs), the electrical machine can provide an interrupted-mode DC Generator or alternating dual-polarity voltage generator and/or an interrupted-mode DC Motor or alternating dual-polarity voltage motor of the special equipment; and
iii) in heating systems for industrial and households use where the electrical machine can provide an interrupted-mode DC Generator or alternating dual-polarity voltage generator and/or an interrupted-mode DC Motor or alternating dual-polarity power motor of the heating system.

The embodiments of the electrical machine can share conditions and features that aid in the conversion efficiency of the machine. Such conditions and features can include:

i) a near optimal condition for direct mechanical energy conversion—achieved by a radial and circular placement of energy generating elements (the elongate radial conductors), by a radial and circular placement of orthogonal magnetic field(s), and by applying perpendicular and radial spin of the energy generating elements within the orthogonal magnetic field(s). The features can achieve near optimal efficiency for direct mechanical energy conversion of an angular rotational motion into direct current energy;

ii) an angular velocity cumulative energy generation function—achieved by a set of elongate radial conductors fixed into a carousel that rotates (spins) in a plan orthogonal to orthogonal magnetic field(s) under a force of applied angular rotational motion (radial angular velocity)—reaching cumulative mechanical energy conversion as a function of angularly growing speed of continuous circular set of radial conductive members. The function provides a direct proportional relation between the number of spinning conductive members in a circular set and the rate of angular velocity, together with magnitude of radius of rotation, the way that more conductive members with higher velocity and growing radius, summarize in higher magnitude of energy conversion. While these features together create angular velocity cumulative phenomenon (the growing magnitude of conversion) between related elements of this system, as a sum of applied functions—reaching for near optimal efficiency for direct mechanical energy conversion into electrical energy;

iii) a phenomenon of maximal magnetic field(s) density and magnitude—achieved by radial and perpendicular orientation of the magnetic or electro-magnetic field(s) and proximity of the magnetic or electro-magnetic poles location. These features create a high magnitude of dense magnetic field(s) flux, which provide during the spin of energy generating elements, phenomenon of cumulative radial induction, within the proximity of poles placement and high magnitude field—wherein all of these elements together deliver near optimal and most efficient way of cumulative interception of magnetic field lines of force to radially induce maximal electromotive force (emf) and concomitant dense, direct current electric energy;

iv) a function of magnitude of radius and angular speed of rotation of the radial elongate conducting members—the angular velocity movement (radial angular speed) during the induction of electromotive force (emf) in the elongate conducting members is a function of magnitude of radius of radial placement of the conductive members (rods) on the peripheral circumference of the spinning carousel. This function depends from the length of radius from a central axis of the carousel rotation to the peripheral edges of the conductive members and relates in direct proportion to the angular velocity rotation. The way that if the magnitude of radius is growing, then so is the angular speed of revolution within a constant rotation motion. These features create angular velocity phenomenon of continuous and cumulative radial velocity induction (maximum cumulative emf induction) of a continuous, direct-current electric energy in the radially and perpendicularly rotating elongated conductive members (rods);

v) a orthogonal phenomenon—the radial placement of the magnetic field(s) of the machine in conjunction with the radial spin of conductive rods as energy converters, create perpendicularity in operation and allows for radial velocity of elongate conducting elements, thus provides optimal perpendicular structure between applied elements of the system as the sum of applied functions;

vi) the radial velocity with radial, continuous set of conductor rods—this creates cumulative operation phenomenon with increasing rotation;

vii) the close proximity of magnetic poles to the radial conductive elements—this creates maximal magnetic flux density and delivers highest possible magnitude of induction of electromotive force (emf) and its concomitant direct current voltage;

viii) the length of the conductive rods (or wires or rotor's winding) is preferably designed to be long, because their length is an important factor to produce/convert large magnitude of direct current power and its voltage;

ix) to accommodate large DC voltage and energy conversion, the electro-magnetic field (not only magnetic), has to be applied to cover entire elongated length of these rods (or wires or rotor's winding) as energy converters (or current activators);

x) the magnetic field is not limited by any magnet's or electro-magnet's shape or set-up (like U-shaped, C-shaped, G-shaped, horse-shoe shaped, cylinder-shaped or ring-shaped) and function as technical preferences or needs or depends from applicability;

xi) the radial crescent-shaped brushes are located by a rule of construction, on the outer radial perimeter (or outside) of the applied magnetics or electro-magnetic field or fields of the electrical machine and to be free of obstruction;

xii) the electro-magnetic field can be applied by a number of electro-magnets arranged in rows expanded radially toward outer perimeter of the rotor's winding;

xiii) the magnetic and especially electro-magnetic fields can be applied by a number of electro-magnets arranged/placed (one inside another) as the circles are placed inside another circle or a rings placed inside another ring; such configurations can accommodate and multiply a greatest magnitude and density of magnetic fields which have to cover the entire carousel's rotor winding—wherein such configurations can be used for large scale generators and motors.

Without deviating from this fundamental perpendicularity principal of operation, there are exists constructional ways that the carousel's rods' conductors could be oriented from the horizontal to vertical position. This means that such special structure of electrical machine allows the conductive rods to be oriented from perpendicular to parallel position to the center axis of rotation but the magnetic fields flux still must be perpendicular to the rotating rods and maintain its perpendicular position. This feature may be useful in small or in constrain way design devices.

It may also be possible to build (construct) an electrical machine according to the principles described herein which has rods of different orientation even if could be less efficient.

There have been described and illustrated herein several embodiments of an electrical machine and method of operating same. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. An electrical machine comprising:
at least one magnet that provides a dipole magnetic field having a primary direction;
a plurality of elongate conductive members that are disposed in a plane that is oriented perpendicular to said primary direction, wherein said elongate conductive members extend radially away from a common central axis that is oriented parallel to said primary direction;
wherein one of the at least one magnet and the plurality of elongate conductive members is rigidly coupled to a rotating shaft that is configured to rotate about the central axis whereby the plurality of elongate conductive members interact with the dipole magnetic field during such rotation.

2. An electrical machine according to claim 1, wherein:
the elongate conductive members are spaced apart from one another with non-electrically-conducting matter therebetween.

3. An electrical machine according to claim 1, wherein:
the non-electrically-conducting matter comprises air.

4. An electrical machine according to claim 1, wherein:
the elongate conductive members each comprise a rod of a solid conductive material.

5. An electrical machine according to claim 1, wherein:
said at least one magnet is fixed in a stationary position; and
the elongate conductive members are configured to rotate about the central axis.

6. An electrical machine according to claim 5, further comprising:
at least one brush that is configured to interface to said plurality of elongate conductive members during rotation of said plurality of elongate members while said plurality of elongate conductive members interact with the dipole magnetic field during such rotation.

7. An electrical machine according to claim 1, wherein:
said plurality of elongate conductive members are fixed in stationary positions; and
said at least one magnet is configured to rotate about the central axis.

8. An electrical machine according to claim 7, further comprising:
at least one brush that is configured to interface to said at least one magnet during rotation of said at least one magnet while said plurality of elongate conductive members interact with the dipole magnetic field during such rotation.

9. An electrical machine according to claim 1, wherein:
said at least one magnet comprises a plurality of magnet unit pairs that are distributed about the central axis on opposite sides of the plane of said plurality of elongate conductive members.

10. An electrical machine according to claim 9, wherein:
said plurality of magnet unit pairs include at least one set of magnet unit pairs that are offset from one another along a radial direction orthogonal to the central axis.

11. An electrical machine according to claim 10, wherein:
for a given set of magnet unit pairs that are offset from one another along a radial direction orthogonal to the central axis, the electro-magnetic field lines of force produced by the magnet unit pairs of the given set increase in coverage area as a function of radial offset from central axis.

12. An electrical machine according to claim 1, wherein:
said at least one magnet comprises at least one permanent magnet disposed on opposite sides of the plane of said plurality of elongate conductive members.

13. An electrical machine according to claim 1, wherein:
said at least one magnet comprises at least one pair of electro-magnets disposed on opposite sides of the plane of said plurality of elongate conductive members.

14. An electrical machine according to claim 1, wherein:
said at least one magnet comprise a pair of annular magnets disposed on opposite sides of the plane of said plurality of elongate conductive members.

15. An electrical machine according to claim 14, wherein:
said pair of annular magnets comprise two electro-magnets disposed on opposite sides of the plane of said plurality of elongate conductive members, wherein each electro-magnetic comprises an annular core with an inner surface disposed opposite an outer surface, an inner winding comprising a plurality of conductive loops supported on the inner surface of the annular core, and an outer winding comprising a plurality of conductive loops supported on the outer surface of the annular core.

16. An electrical machine according to claim 15, wherein:
the conductive loops of the inner winding are configured to carry current in a first direction about the central axis of the annular core, and the conductive loops of the outer winding are configured to carry current in a second direction about the central axis of the annular core, wherein the second direction is opposite the first direction.

17. An electrical machine according to claim 16, wherein:
the conductive loops of at least one of the inner winding and the outer winding comprise a plurality of layers.

18. An electrical machine according to claim 1, further comprising:
at least one electrical circuit that provides for electric current flow through said plurality of elongate conductive members during rotation of said shaft.

19. An electrical machine according to claim 18, wherein:
said at least one electrical circuit provides for electric current flow through a number of elongate conductive members during predetermined rotational intervals of said shaft.

20. An electrical machine according to claim 18, wherein:
said at least one electrical circuit includes a plurality of electrical circuits that provide for a number of electric current flows through said plurality of elongate conductive members during rotation of said shaft.

21. An electrical machine according to claim 18, wherein:
said at least one magnet covers limited subsets of said plurality of elongate conductive members at corresponding predetermined rotational intervals of the electrical machine, and
said at least one electrical circuit includes a commutator element that connects the limited subsets of said plurality of elongate conductive members at the corresponding predetermined rotational intervals of the electrical system.

22. An electrical machine according to claim 21, wherein:
said commutator element is disconnected from at least one elongate conductive member that is not covered by said at least one magnet at the predetermined rotational intervals of the electrical machine in order to limit current leakage through the at least one elongate conductive member that is not covered by said at least one magnet.

23. An electrical machine according to claim 21, wherein:
said commutator element rotates with said shaft.

24. An electrical machine according to claim 18, wherein:
said at least one electrical circuit includes a plurality of diodes that limit current flow through said plurality of elongate conductive members in order to limit current leakage through said plurality of elongate conductive members.

25. An electrical machine according to claim 18, wherein:
said at least one electrical circuit carries unidirectional direct current flow during rotation of said shaft.

26. An electrical machine according to claim 18, wherein:
said at least magnet comprises at least two magnets that produce dipole magnetic fields of opposite polarity with respect to one another; and
said at least one electrical circuit carries bidirectional current flow during rotation of said shaft.

27. An electrical machine according to claim 18, wherein:
the rotating shaft is driven by an external source, and said at least one electrical circuit produces electric current flow induced by interaction between the plurality of elongate conductive members and the dipole magnetic field produced by the at least one magnet during rotation of said shaft.

28. An electrical machine according to claim 27, wherein:
the electric current flow is continuous direct current.

29. An electrical machine according to claim 27, wherein:
the electric current flow is interrupted direct current.

30. An electrical machine according to claim 27, wherein:
the electric current flow is alternating dual-polarity current.

31. An electrical machine according to claim 27, wherein:
the at least one electric circuit includes a plurality of electric circuits that produce a corresponding plurality of electric current flows induced by interaction between the plurality of elongate conductive members and the dipole magnetic field produced by the at least one magnet during rotation of said shaft, wherein the plurality of electric current flows vary over time with predetermined phase relations.

32. An electrical machine according to claim 18, wherein:
said at least one electrical circuit is supplied with electric current flow from an external source, wherein the electric current flow induces interaction between the plurality of elongate conductive members and the dipole magnetic field produced by the at least one magnet to drive rotation of said rotating shaft.

33. An electrical machine according to claim 18, wherein:
in a generator mode, the rotating shaft is driven by an external source, and said at least one electrical circuit produces electric current flow induced by interaction between the plurality of elongate conductive members and the dipole magnetic field produced by the at least one magnet during rotation of said shaft; and
in a motor mode, said at least one electrical circuit is supplied with electric current flow from an external source, wherein the electric current flow induces interaction between the plurality of elongate conductive members and the dipole magnetic field produced by the at least one magnet to drive rotation of said rotating shaft.

34. An electrical machine according to claim 1, further comprising:
multiple stages each with a corresponding set of elongate conductive members and associated at least one magnet, the multiple stages generating or receiving a plurality of electrical signals.

35. An electrical machine according to claim 34, wherein:
the plurality of electrical signals have predefined phase offsets.

36. An electrical machine according to claim 34, further comprising:
combining the plurality of electrical signals as generated by the electrical machine for output.

37. An electrical machine according to claim 36, wherein:
the plurality of electrical signals are combined by at least one of a parallel electrical connection and a serial electrical connection.

38. An electrical machine according to claim 1, wherein:
the elongate conductive members are partitioned into groups that generate or receive a plurality of electrical signals.

39. An electrical machine according to claim 38, wherein:
the plurality of electrical signals have predefined phase offsets.

40. An electrical machine according to claim 38, further comprising:
combining the plurality of electrical signals as generated by the electrical machine for output.

41. An electrical machine according to claim 40, wherein:
the plurality of electrical signals are combined by at least one of a parallel electrical connection and a serial electrical connection.

42. An apparatus for generating an electromagnetic field, comprising:
an annular core with an inner surface disposed opposite an outer surface;
an inner winding comprising a plurality of conductive loops supported on the inner surface of the annular core; and
an outer winding comprising a plurality of conductive loops supported on the outer surface of the annular core.

43. An apparatus according to claim 42, wherein:
the conductive loops of the inner winding are configured to carry current in a first direction about the central axis of the annular core; and
the conductive loops of the outer winding are configured to carry current in a second direction about the central axis of the annular core, wherein the second direction is opposite the first direction.

44. An apparatus according to claim 42, wherein:
the conductive loops of at least one of the inner winding and the outer winding comprise a plurality of layers; and/or
each conductive loop of the inner winding and the outer winding extend in a plane that is substantially orthogonal to the central axis of the annular core.
